(19) United States
(12) Patent Application Publication
(10) Pub. No.: US 2026/0064814 A1
(43) Pub. Date: Mar. 5, 2026

(54) SYSTEMS AND METHODS FOR GENERATING AND IMPLEMENTING CAPTURE PROTECTIONS POLICIES

(71) Applicant: Adeia Guides Inc., San Jose, CA (US)

(72) Inventors: Jean-Yves Couleaud, Mission Viejo, CA (US); Reda Harb, Tampa, FL (US)

(21) Appl. No.: 18/819,272

(22) Filed: Aug. 29, 2024

(51) Int. Cl. G06F 21/10; H04L 9/40

(52) U.S. Cl. CPC G06F 21/1013; H04L 63/107

(57) ABSTRACT

Systems and methods for implementing restriction policies for capturing and sharing of media content associated with a first user, by a second user, without consent, are described. A request to capture or share media content associated with a target, by a device such as a smartphone or a drone, is detected. A search query is automatically generated to search for restrictions policies. Upon identifying a restriction policy, restriction patterns and metadata which include rules and restrictions for capturing and sharing of the media content are downloaded to the device. A match between the restriction patterns and the media content to be captured are made. Upon confirming a match, restrictions from the policy are applied to the media content, which include altering a portion or an attribute of the media content such that it is unrecognizable. Watermarks may also be embedded within the media content files to enforce the policy.

### FIELD OF DISCLOSURE

Embodiments of the present disclosure relate to generating and implementing capture protection policies using pattern recognition techniques for preventing unauthorized capturing and storing of digital media associated with the target using an electronic device and detecting and preventing sharing or disseminating of the data on one or more platforms.

### BACKGROUND

Taking pictures with electronic devices and posting them online, such as sharing them on Instagram or TikTok, among other social media platforms, has become very common. People often take pictures of themselves as well as others and post them online on various social media platforms. Posting your own picture is one thing but posting someone else's picture on social media without the consent of the person or persons featured in that picture raises significant privacy, legal, and safety concerns. The problem is exacerbated due to the easy and widespread use of social media platforms that allows the click and post culture without thinking whether the capturing and sharing of the picture violate others' privacy and safety.

Individuals whose images are shared without their permission face a multitude of potential harms. For example, unwanted exposure to a broad audience, including strangers and potential employers, can lead to emotional distress and reputational damage. Moreover, once an image is online, it is difficult to control its dissemination and potential misuse, leaving individuals vulnerable to identity theft, harassment, or other malicious activities.

The issue extends beyond images to other forms of media, such as audio clips, video snippets, or videos with longer length. Any content that can identify an individual or their property is susceptible to unauthorized sharing and the subsequent privacy violations that may entail.

Currently, there is no comprehensive solution to prevent the unauthorized capturing, storing, or sharing of images, audio, or video of objects, structures, and people. Existing protections are often platform-specific and ineffective in preventing content migration and indexing by search engines. For example, a social media platform, such as Facebook may allow an individual, such as John, to un-tag his name when someone else posts John's picture on their Facebook feed and tags it with John's name. Such a solution is very limited because if the picture was not tagged, John would not have knowledge of his picture circulating online. Furthermore, John's action of un-tagging is only reactionary: it can be taken only once the picture is posted online and John is informed of the posting. Such reaction and un-tagging may be too late in the sense that many people may have already seen John's picture prior to John un-tagging the picture. Furthermore, such un-tagging only makes John's picture harder to find in searches and does not regulate or prevent sharing of the picture.

Accordingly, for at least the reasons described above, the ability to easily capture and distribute content online, coupled with the lack of robust protective measures, has created a significant privacy, safety, and legal problem.

As such, there is a need for systems and methods that safeguard a person's rights, including their privacy and safety, as they relate to capturing, storing, and sharing digital media associated with a person, object, or a structure.

### BRIEF DESCRIPTION OF THE DRAWINGS

The various objects and advantages of the disclosure will be apparent upon consideration of the following detailed description, taken in conjunction with the accompanying drawings, in which like reference characters refer to like parts throughout, and in which:

FIG. 1 is a block diagram of an exemplary process for detecting or generating a policy and implementing the policy related to capturing and sharing of data, in accordance with some embodiments of the disclosure;

FIG. 2 is a block diagram of an exemplary system for detecting or generating a restriction policy and implementing the restriction policy related to capturing, storing, and sharing of data, in accordance with some embodiments of the disclosure;

FIG. 3 is a block diagram of an exemplary user device used for capturing, storing, and sharing of data, implementing data capture, store, and share policies, and uploading data to various platforms, in accordance with some embodiments of the disclosure;

FIG. 4 is a flowchart of an exemplary process for detecting or generating a policy and implementing the policy related to capturing and sharing of data, in accordance with some embodiments of the disclosure;

FIG. 5 is an example of a user interface of a capture device restricting the capture of a person based on a policy, in accordance with some embodiments of the disclosure;

FIG. 6 is a flowchart of an exemplary process for determining a restricted pattern and modifying data captured based on the rules and policies associated with capturing and sharing of the restricted pattern, in accordance with some embodiments of the disclosure;

FIG. 7 depicts examples of functions performed by a device and sharing platform server for capturing and posting data on a sharing platform, in accordance with some embodiments of the disclosure;

FIG. 8 is a flowchart of an exemplary process for a sharing platform server to detect and implement a policy associated with posting or sharing data on the sharing platform, in accordance with some embodiments of the disclosure;

FIG. 9 is a flowchart of exemplary communications between various components of a system for detecting or generating a policy and implementing the policy related to capturing and sharing of data, in accordance with some embodiments of the disclosure;

FIG. 10 is an example of a flowchart of a process for filling in blanks, during a policy creation stage, for an uploaded image that is a structure by adding additional images, in accordance with some embodiments of the disclosure.

FIG. 11 is an example of an outline drawn around a home to list the home's pattern in a restriction policy, in accordance with some embodiments of the disclosure;

FIG. 12 is an example of a block diagram for manually generating a policy, in accordance with some embodiments of the disclosure;

FIG. 13 is an example of a block diagram for automatically generating and revising a policy, in accordance with some embodiments of the disclosure;

FIG. 14 is a block diagram of examples of actions that may be performed to implement a policy, in accordance with some embodiments of the disclosure;

FIG. 15 is a block diagram of examples of conditions included in metadata associated with a restricted pattern, in accordance with some embodiments of the disclosure; and

FIG. 16 is a flowchart of an exemplary process for implementing the policy for a drone, in accordance with some embodiments of the disclosure.

### DETAILED DESCRIPTION

In accordance with some embodiments disclosed herein, some of the above-mentioned limitations are overcome by generating restriction policies that define rules and restrictions that a capturing device (also referred to as capture device) must follow when capturing, storing, or sharing digital media content associated with a target via a camera or microphone of a capturing device without prior consent from the first user.

In some embodiments, a detection may be made that an electronic device is attempting or requesting to capture digital media associated with a target, such as take the target's picture or record audio and/or video of the target. As referred to herein, digital media includes images, audio, video, or any combination thereof relating to a target (See target described below). For example, it also includes a person's appearance, including their face and body, and their speech. It includes all forms of audio, including music generated by a person or sound coming from a structure, such as a home. It also includes images, audio, video, or any combination thereof relating to structures such as residential property, commercial property, farm, venue space, such as a concert hall, sports stadium, or any other type of property or structure. Also, as referred to herein, a target may be any person, structure, object, scenery, or landscape, that is to be captured by the capture device. For example, the target may be an adult, child, celebrity, or well-known figure. The target may be a person wearing different types of clothing, such as bathing suit or business casual clothes. The target may be physical or non-physical, such as a voice, music, or other type of sound. In other words, the target may be anything that can be captured using a camera of the capture device or recorded using a microphone or camera of the capture device. The target may be a whole or a portion or specific attribute of a person, structure, object, scenery or landscape. For example, while capturing a face of a woman may be allowed, a capture revealing portions of her body may be restricted, and if the target may be identified as such, it may be restricted.

Upon detection, the target's location and/or other parameters may be determined. The location may be determined to use in a search query to identify restriction policies for the location, e.g., within a threshold distance of the location. In addition to location, or alternatively, other parameters associated with the target may also be used to search for the associated restriction policy. To determine the target's location during capture, in one embodiment, the capturing device's location may be obtained and used to estimate the target's location. For example, as will be described in further detail below, the target's location may be estimated based on the capturing device's type (e.g., model, type, camera range, depth perception, etc.).

In some embodiments, based on the search conducted, a restriction policy related to the search parameters (e.g., target location) may be identified. The search process may involve a server or the capturing device automatically composing a query with search parameters, which may be those related to the target, without user intervention. If the search yields one or more policies, these policies can be used to determine permitted and prohibited actions regarding capturing, storing, and sharing digital media associated with the target. For targets not tied to a geographic location, such as voice prints or facial features, the system may still calculate the probability of a region covered by a capture device intersecting or traversing a region where the target is present.

The restriction policy and rules within the restriction policy may be uploaded to a privacy platform by a user by logging into the privacy platform using credentials such as a username and password. In some embodiments, a privacy platform may allow authorized users to upload images, videos, audio and generate rules and restrictions associated with the uploads. The privacy platform may also interact with the capture device and sharing platform to perform inserting, encoding, and decoding of watermarks that are associated with restrictions placed on the content uploaded. In some embodiments, the privacy platform acts as an intermediary that processes verifications of policy, determining which restrictions apply to content being shared, perform implementations of policy restrictions, perform alterations of content in adherence to the policy rules and restrictions, and provide guidance to sharing platforms relating permitting or restricting sharing of content. In some embodiments, the privacy platform may generate a public key that allows the capture device to add a watermark and encrypt the payload associated with the watermark. The public/private key encryption methods utilize a public and a private key generated using cryptographic algorithms to encrypt and decrypt content. A private key may later be used for decoding a watermark by an authenticated user of the marked content. In some embodiments, the user's identity, ownership, and authority may be analyzed prior to allowing the user to upload restrictions of others trying to capture the digital content/media content representing the target. In some embodiments, such verification of the user's identity, ownership, and authority may prevent users who are not authorized to impose restrictions on others or other property the capture or sharing of which they have no right to prevent.

In some embodiments, the policy may define that the capturing, storing, or sharing of digital media representing the target or a portion thereof is allowed with certain alterations or modifications. Examples of such restrictions may include blurring or overlaying on a portion of the target that is restricted such that, after blurring and/or overlaying, the target is not identifiable or recognizable. The overlay may hide the underlying portion of the digital media associated with the target. The overlay may be another object, avatar, or a pattern.

To determine whether the target is the same as the content described in the policy, e.g., the person or home being photographed without consent is in fact the same person or home that has restrictions associated with them or it in the policy, an analysis may be performed to match pattern(s) and attributes of the target being captured and/or shared with pattern(s) and attributes in the restriction policy. For example, if a house has a backyard pool that is restricted, the policy may require blurring of the pool portion of the target when the house is being photographed to protect the privacy of people in the pool.

In some embodiments, to determine a match, the capture device may be loaded with restricted patterns from the policy. The capturing device, using the loaded patterns, may then determine whether patterns and attributes of the target being captured or shared match restricted patterns and/or attributes in the policy. Mechanisms such as image recognition, artificial intelligence, Computer Vision (CV), and machine learning may be used to determine a match. In some embodiments, the process of pattern matching may include steps of a) data acquisition, filtering and buffering, b) features extraction, and c) pattern matching based on the acquired data and feature extraction. In some embodiments, the restriction policy may allow for a predetermined margin of error such that targets that are captured at different angles, resolution, depth, and orientation are also considered when performing a pattern match.

In other embodiments, pattern matching may involve a server to compare image patterns by converting images into numerical representations, often called feature vectors (such as the images uploaded by a user to identify restrictions patterns within the image or images about to be captured and visible in the viewfinder of a camera). These vectors encapsulate essential image characteristics like color, texture, and shape. Advanced algorithms extract key points within these images, known as interest points, that are particularly distinctive. These interest points are then described using mathematical descriptors. By comparing these descriptors between images, the server calculates a similarity score. A higher score indicates a greater likelihood of the images containing similar patterns. This process, often involving techniques like SIFT, SURF, or ORB, allows for efficient and accurate image comparison on a large scale. In some embodiments, content from the restriction policy, which includes portions that may be allowed and potions that may be subject to the policy, i.e., the restricted patterns, may be used for comparing with patterns from target to be captured or shared to determine if they match the restricted pattern in the policy and if so implement the policy for the portion of the target that matches the restricted pattern.

In some embodiments, if a match is determined, i.e., a portion of the digital media associated with the target being captured or shared, such as the pool is restricted and its capturing or sharing is allowed only if the restricted portion, e.g., the pool is altered, then the alterations may be performed prior to allowing its capturing, storing or sharing. The alteration may be performed by any one of capturing device, the privacy platform, or the social media platform where the target is being shared.

In addition to the alterations, the capturing device may also insert a watermark on the captured image or audio. The watermark may act as a notification or flag that the target is associated with a restriction policy. As such, any device, or media platform on which an attempt or request to share the target is made shall ensure and enforce, based on its capabilities, that a policy is implemented. The device or media platform may then allow the capturing, storing, or sharing of digital media associated with the target (e.g., depicting the target) only after the policy restrictions have been implemented. In some embodiments, the media platform, such as a social media platform, may determine whether the restrictions from the policy were already applied by the capturing device or the privacy platform. If so, then the social media platform may allow posting of the digital media associated with the target (e.g., its image, video, or audio) associated with the restriction policy. In the event that policy restrictions cannot be implemented, e.g., the device does not have the capability of blurring the restricted portion, then a notification may be sent to the user who uploaded the restricted pattern, and/or the capturing, storing, or sharing of the digital media associated with the target may be prevented. The notification may inform the user that the restriction cannot be applied and a default policy, which does not permit capture or sharing, may be implemented.

On the other hand, if a determination is made that the target does not have a policy or has a policy but the portion of the target that is in the viewfinder and being captured or shared is not restricted, then the capture device may suspend any target alteration, modification, or transformation process and resume the normal capture or sharing of the digital media associated with the target or portion thereof.

In some embodiments, the restriction policy may include multiple restriction patterns that may be conditional upon each other. As described herein, a restriction pattern is a restricted image, video, or audio, or a portion thereof, that is subject to a policy. For example, an image may have some of its portions subject to a restriction policy, those portions are referred to as being associated with a restriction pattern. The control circuitry may generate a pattern based on any content uploaded to a privacy platform. The user that uploads the content may then identify, such as by using a user interface, portions of the image as restricted and subject to rules and restrictions of a policy. The control circuitry may generate a separate pattern from the entire image, which is known as the restricted pattern. In the example of a person's image, the restricted patterns may be generated that restrict their face, entire body, the person in different positions, such as jumping, bending, or consuming food. The control circuitry may generate a pattern for such restrictions and store them as restricted patterns.

In some embodiments, rules such as IFTTT may be associated with such restricted patterns where if X is heard or visible in the target then a first set of rules shall apply and if Y is heard or visible in the target, then a second set of rules shall apply. Taking the example of the pool, if a house is in the viewfinder of a camera, then its capture may be allowed; however, if the pool by itself or the house with a pool is visible in the viewfinder of a camera, then the second restriction, which may prevent the capture or require blurring of the pool, may apply.

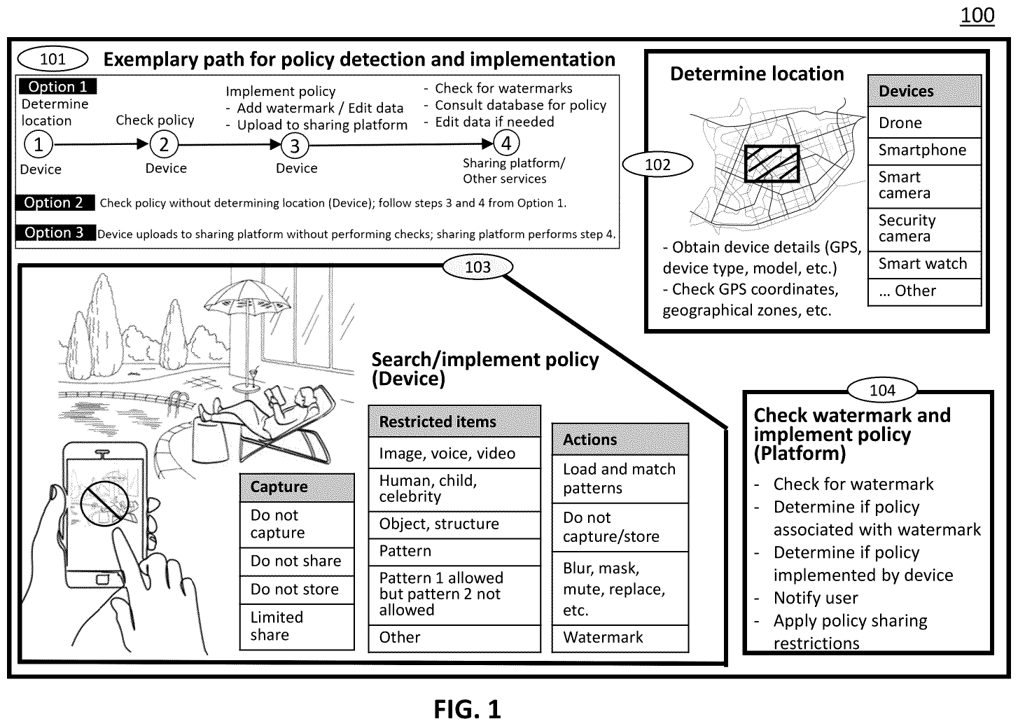

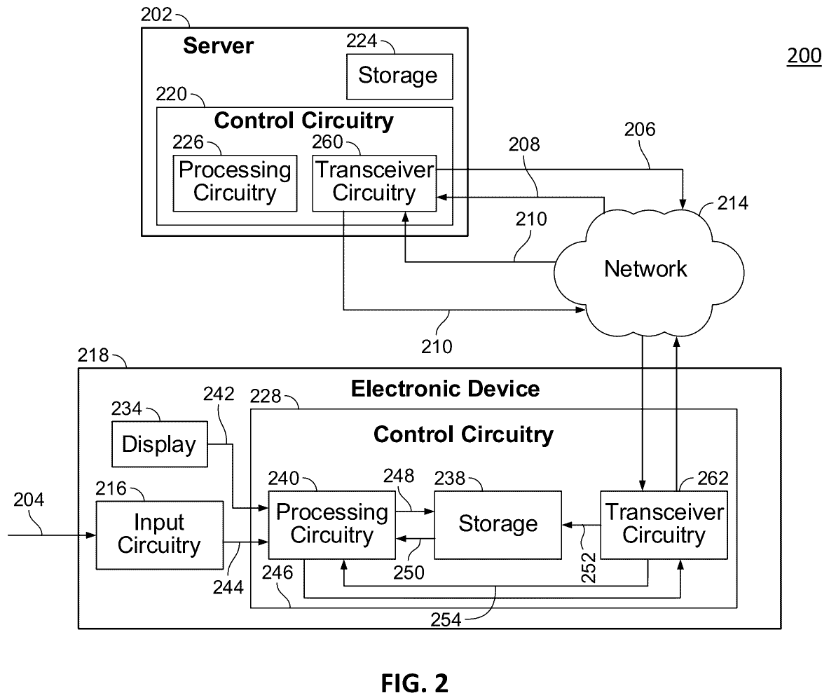

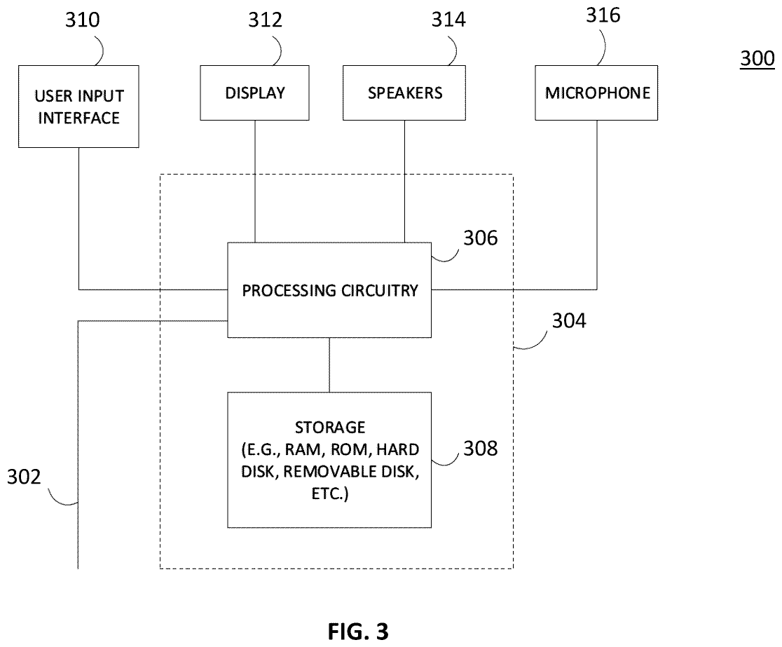

Turning now to the figures, FIG. 1 is a block diagram of an example of a process 100 for detecting or generating a policy and implementing the policy related to capturing and sharing data, in accordance with some embodiments of the disclosure. The process 100 may be implemented, in whole or in part, by systems or devices such as those shown in FIGS. 2 and 3. One or more actions of the process 100 may be incorporated into or combined with one or more actions of any other process or embodiments described herein. The process 100 may be saved to a memory or storage (e.g., any one of those depicted in FIGS. 2 and 3) as one or more instructions or routines that may be executed by a corresponding device or system to implement the process 100.

In some embodiments, a plurality of path options may be taken for detecting or generating a policy and implementing the policy related to capturing and sharing of data. Some options that may be used include options 1-3 depicted at 101. Blocks 102-104 may be used, in some embodiments, when option 1 is used. Although option 1 is depicted in blocks 102-104 and its description is provided below, the embodiments are not so limited and other paths, such as options 2 and 3 are also contemplated within the embodiments.

In some embodiments, at block 101, control circuitry of a system, such as control circuitry 220 and/or 228 of system 200 in FIG. 2, determines the location of a target that is being captured by a capture device.

As referred to herein, the capture device (also referred to as capturing device or device) may be any electronic device that includes a camera or is associated with a camera for capturing an image, taking a video, or recording audio and has the capability to communicate the captured data over a network to another device or platform. Some examples of capture devices include a drone (including a delivery drone), smartphone, smart camera, security camera, IoT camera of any type, traffic light camera, smart watch, laptop, and tablet computer.

In some embodiments, at block 102, the location of the target is determined such that a policy that guides the capture of the digital media associated with the target and its sharing may be identified. Since there may be numerous policies generated either by users or automatically generated for capture of targets around the world, the policy may be anchored to a location, such a region, city, neighborhood, etc., such that a narrower and more focused search can be conducted to identify the one or more policy associated with the target.

Although location may be one parameter to narrow the search for a policy, the embodiments are not so limited. Other parameters, such as name of person or object, person, or object ID number (which may be a reference number generated by the privacy platform to associate a person or object with an assigned number), zones or regions, and/or any other searchable parameters may also be used to conduct a focused and narrow search for a policy associated with the target. The policies may be tagged with such parameters such that the policies may be searched using the parameter in the query. Any combination of parameters with the location, such as location and a policy created or effective within a certain date or time period, may also be used for a focused and narrow search.

In some embodiments, determining the location, at block 101, by the control circuitry 220 and/or 228 of system 200 may include identifying geographical coordinates such as latitude, longitude, and a radius or perimeter around these coordinates of the target being captured.

As shown in block 102, the location of the target to be captured may also be determined, in one embodiment, based on the type of capture device being used. For example, a type of capture device that is a smartphone may have a certain range of camera for which it may capture a target. If the smartphone is equipped with a long range zoom lens, the range may be more than a smartphone with no zoom lens or a standard zoom lens with a lesser range. If the type of capture device is a drone, the range may be longer since the drone is able to fly at high altitude and have a larger field of vision from its camera. As such, based on the type of device used and its camera's range, a distance, range, radius, or perimeter from the capture device and the target may be predicted. In other words, a determination may be made that the target is likely within the camera range of the capture device and based on that determination an approximate location of the target may be determined.

In one example, a threshold distance around the capture device may be used as location in which the target is likely present. For example, if a capture device is a smartphone and the capture being performed is a portrait mode, which is used for close up pictures of people, since most individuals stand within a five, fifteen, to 50-foot distance from the camera when their portrait is being taken, a determination may be made that the target is within 50 feet of the capture device. In another example, when the smartphone is taking a regular picture (without zoom) or is in a panorama mode, which captured targets at farther distances, a determination may be made that the target is likely within 100 yards of the camera. Although a camera in its regular mode may view targets that are visible miles away, since such targets may appear very small or not clearly distinguishable due to their distance, such long ranges may not be used to identify the location of the target. In yet another example, a depth perception or depth range analysis may be made based on an image focused on a viewfinder of the camera. Based on the depth perception, which may be derived using image processing techniques, such as monocular depth estimation, and other techniques, the depth or distance from the camera to the target may be calculated within a margin of error. In yet another embodiment, if the capture device is a drone, which has a field of view of one to five miles, then a determination may be made that the target is likely within one to five miles of the capture device. The threshold distances may be set based on the location of the capture device, type and model of the capture device, the type of camera used within the capture device and its range, and other parameters that provide an indication of the device's capture range. The threshold distance may be modified by the user or automatically by the system.

In some embodiments, type and range of the capture device may be used to set a range around the device for the purposes of identifying a location, radius or perimeter, or range within which the target object is likely to be located. The capture device's geographical coordinates such as latitude, longitude, and a radius or perimeter around these coordinates may also be used to estimate an approximate location of the target.

The range may also be adjusted based on the location of the capture device. For example, if the capture device is in an urban area with a lot of tall buildings within close proximity, since the range of view of the capture device may be a short range limited by the tall buildings obstructing its view, a threshold distance for the target may be determined to be within one to three blocks of the capture device. In another example, if the capture device is in a rural environment with long-range visibility and no buildings or other blocking objects in its way, then, since the range of view of the capture device may be a larger range due to not having any obstructions, a threshold distance for the target may be determined to be up to one mile. The one to three blocks or one mile ranges are exemplary and may be adjusted as needed.

In some embodiments, the capture device may convey or communicate its own geographic location to a privacy platform or another server or control circuitry, such as the server or control circuitry 220 and/or 228 described in FIG. 2. In case of a device with high mobility such as a drone, the privacy platform may select a wider threshold range than for a device of lower mobility, such as a smartphone carried by a pedestrian to determine the potential location of a target that may be captured by the capture device.

In case of a target that is not attached to a geographic location, such as the voice print or the face of a user, the privacy platform may still compute a probability of a region covered by a capture device to intersect or transect with a region in which the target is present. The probability of the target location may be computed using the last known location of the target's own capture device, such as the target's smartphone. To ensure that this information is available, the privacy platform may have requested the registration of a smartphone when registering a new user-attached restriction pattern. For example, a user may only be allowed to upload their images, video, and audio files and associated restriction patterns if the user's device shares their device location.

Once a location has been established, at block 103, a search may be conducted to determine whether a policy that is associated with the location exists. As described earlier, location may be only one of the parameters that may be used to search for the policy. In addition to, or instead of location, other parameters such as a target's name, or target's features, or any descriptive attributes associated with the target may also be used to search for the policy.

The “policy,” as referred to herein, in some embodiments relates to any one or more of rules, regulations, policies, and conditions, that allow the capture of digital media associated with the target, storing of data related to the capture; sharing of the captured data, including sharing with other devices or sharing by posting on a sharing platform; posting of captured data associated with the target on a sharing platform; and attaching files that include the target with others. The policy also relates to recording or sharing of audio, such as a person's speech, song, music played by a person, etc. Accordingly, the policy may define all rules associated with capture and sharing of the target, including sharing, or posting it on sharing platforms. As referred to herein, a sharing platform may be a media platform, such as a social media platform, such as Facebook, X (formerly Twitter), Instagram, Google Photos, YouTube, Pinterest, Snapchat, Reddit, TikTok, WeChat, Tumblr, LinkedIn, Quora, or Vimeo. It may also include live streaming platforms such as Facebook Live, YouTube Live, Twitch, Dacast, and Restream. Sharing platforms may also include messenger sharing platforms where groups may be established and data may be shared in the groups, such as WhatsApp, Viber, Discord, Telegram, Slack, and Google Chat. It may also include live video sharing platforms in which data can be shared, such as Zoom, Microsoft Teams, GoToMeeting, Google Meet, and Webex. Sharing platforms may further include audio sharing platforms, including podcast platforms, such as Buzzsprout, Captivate, CoHost, Transistor, Podbean, and Blurry.

In some embodiments, the policy may define what type of capture is allowed and what type of capture is restricted. These restrictions may include, a) do not capture, b) do not share, c) do not store, d) allow limited sharing or e) allow capturing or sharing digital media associated with the target after transforming the digital media associated with the target (e.g., its image, video, or audio) according to the rules set forth in the policy, such that it is not recognizable. Additional restrictions may also be generated by a user or automatically by the control circuitry 228 and/or 220 and added to the policy.

With respect to the a) “do not capture” restriction described above, which relates to preventing or restricting capture of the target, in some embodiments, the restriction may be implemented at the stage of capture. In other words, when a target is in the viewfinder of a camera of the capture device, and an option to capture the target is selected by a user, such as by pressing a “take picture” button on their smartphone, the control circuitry 220 and/or 228 may implement the policy and restrict the capturing of the picture. In other words, the user may press a button on their smartphone to take a picture, however, the picture may not be captured, and optionally, a message may be displayed in the viewfinder that capturing the digital media associated with the target is restricted based on a policy. In some embodiments, the “do not capture” restriction may be implemented at the device itself. For example, if a user presses a smartphone button for taking a picture of an individual, the smartphone may implement the policy and restrict taking/capturing of the picture if the policy prevents such a capture. Likewise, in another example, an aerial drone attempting or requesting to snap a picture of an individual's backyard may be prevented from capturing such a picture if a policy prevents such a capture.

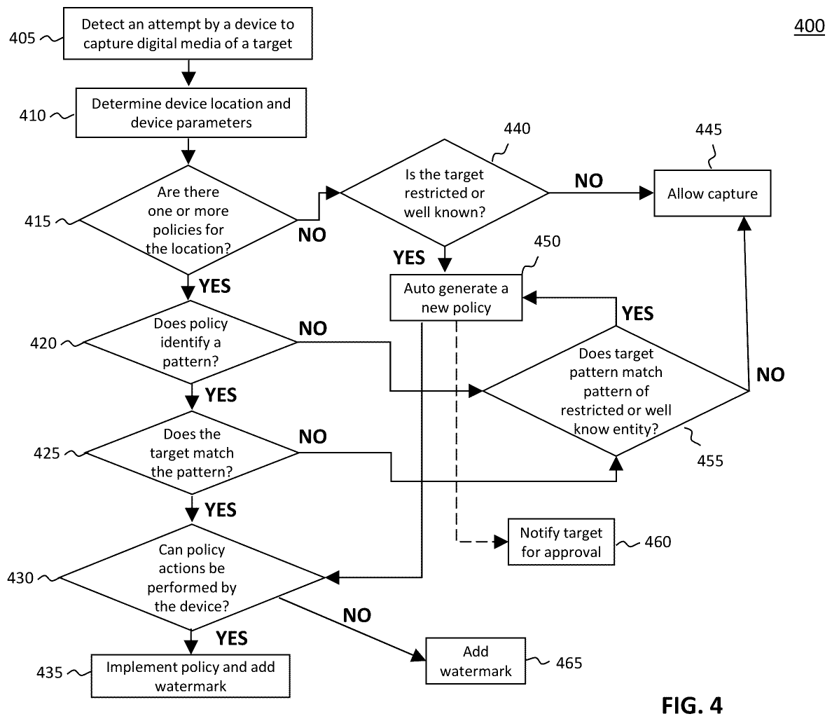

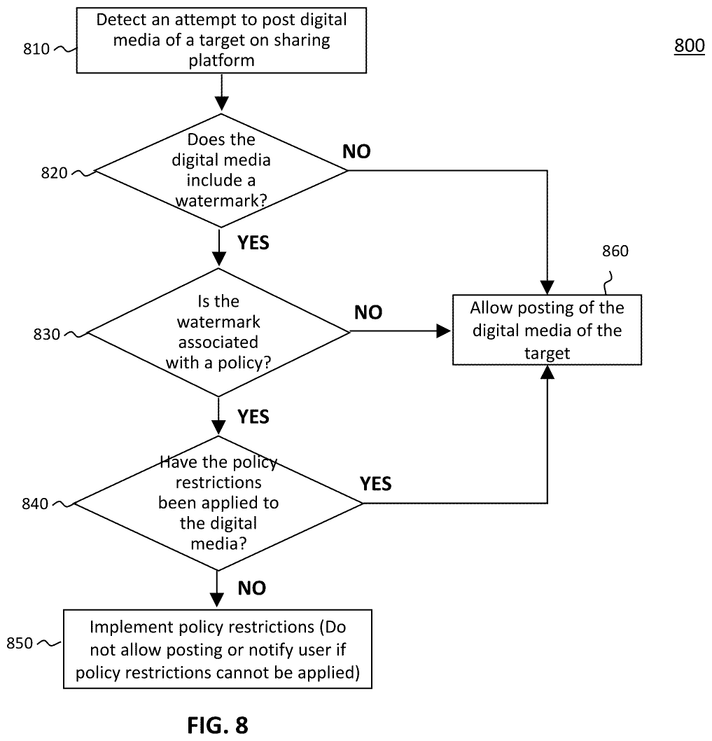

With respect to the b) “do not share” restriction described above, which relates to preventing or restricting sharing of the captured digital media associated with the target, in some embodiments, the restriction may be implemented to prevent sharing or posting on a sharing platform of the captured target. In some embodiments, the “do not share” restriction may be implemented either at the device or at the sharing platform. In one embodiment, the device capturing the picture may be used for uploading to a sharing platform. When a detection is made at the device that the captured image is being shared or posted on a sharing platform, the device itself may perform functions to determine whether the sharing and posting is authorized according to the policy and take appropriate actions to follow the policy and its instructions. In other embodiments, the “do not share” restriction may be implemented at the sharing platform. In this embodiment, if a target is being uploaded to the sharing platform, the sharing platform may determine whether authorization is provided according to a policy for sharing and posting the target on its platform. In yet other embodiment, as will be discussed in more detail in relation to FIGS. 4 and 8 the device may add a watermark to the captured image that may be used to indicate to the sharing platform to check/search for the policy associated with the watermark and accordingly allow or disallow the sharing and posting based on the policy.

With respect to the c) “do not store” restriction described above, which relates to storage of the captured target, in some embodiments, the restriction may be implemented at the device or at the storage (e.g., external storage). In this embodiment, the device or the storage unit may check to determine whether the policy authorizes storing of the target's capture.

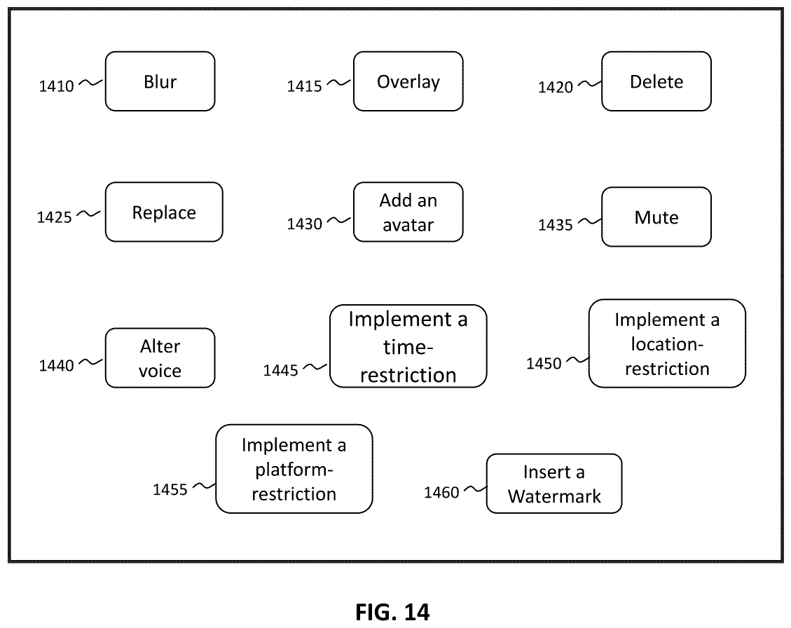

With respect to the d) “limited sharing” restriction described above, which relates to sharing of the digital media associated with the target based on certain limitations, sharing of the captured target may be allowed under certain limited conditions or on certain limited platforms. For example, as will be discussed in further detail below in relation to FIG. 14, the sharing may be subject to transforming the target, such as by blurring or masking certain portions of the captured target. In another example, the sharing may be allowed on one platform, such as LinkedIn, and not allowed for another platform, such as Facebook. In this embodiment, the restriction may be implemented either at the device or at the shared platform.

With respect to the e) capturing or sharing after transforming the digital media associated with the target (e.g., its image, video, or audio) according to the rules set forth in the policy such that it is not recognizable, the transformation may be performed at the device, or the device may watermark the target such that the shared platform may perform the transforming of the target based on the policy.

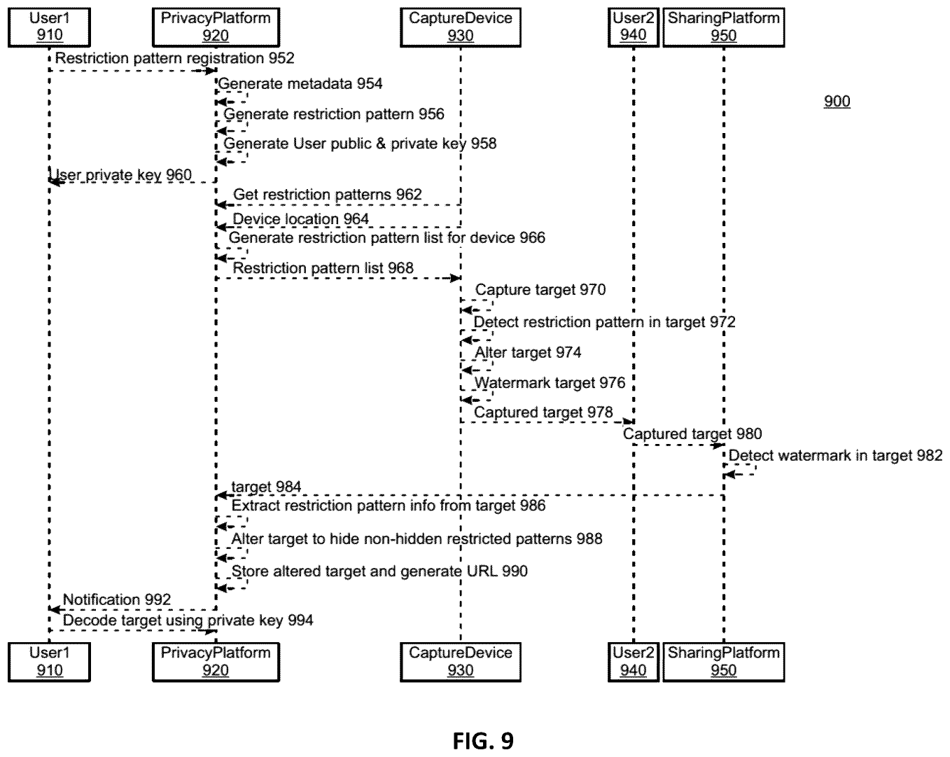

In some embodiments, the policy may include patterns that are to be used as a guide to determine which targets are restricted for capturing, sharing, and or posting. The target, e.g., its pattern, may be matched with the restricted pattern to determine whether a policy for capturing and sharing associated with the matching restricted pattern exists. Some examples of patterns may include a pattern of the front face of a house, a pattern of an individual, and a pattern of an object. One embodiment of generating and storing patterns, i.e. restricted patterns, is described further in the description of FIG. 9. In another embodiment, the policy may include a restricted items list that is to be used as a guide to determine which targets are restricted for capturing, sharing, and or posting. The target, e.g., description, name, or other descriptive information in a textual format, may be matched with the list of restricted items list to determine whether a policy for capturing and sharing associated with the matching restricted items list exists. The list may include an address of a house or name of an individual, place, or object. In addition to pattern matching and matching with a list of items, additional matching parameters may be added by the user of the system or automatically by the control circuitry 220 and/or 228.

With respect to pattern matching, the process may be initiated by loading the capture device with a database of patterns and associated metadata to indicate restrictions in the media capture and sharing process. In some embodiments, since the pattern data may require a large memory space, only policies and patterns relevant to a location where the target is being captured may be loaded. In other words, since many policies may exist for different targets in the region, a focused search may be conducted of the likely location of the target and, based on the determination of the approximate location of the target, the policy and associated patterns that are tagged with the location may be loaded. In other embodiments, the policy and patterns may be loaded to an external storage that is accessible by the capture device, and a link to the stored location may be provided to the capture device.

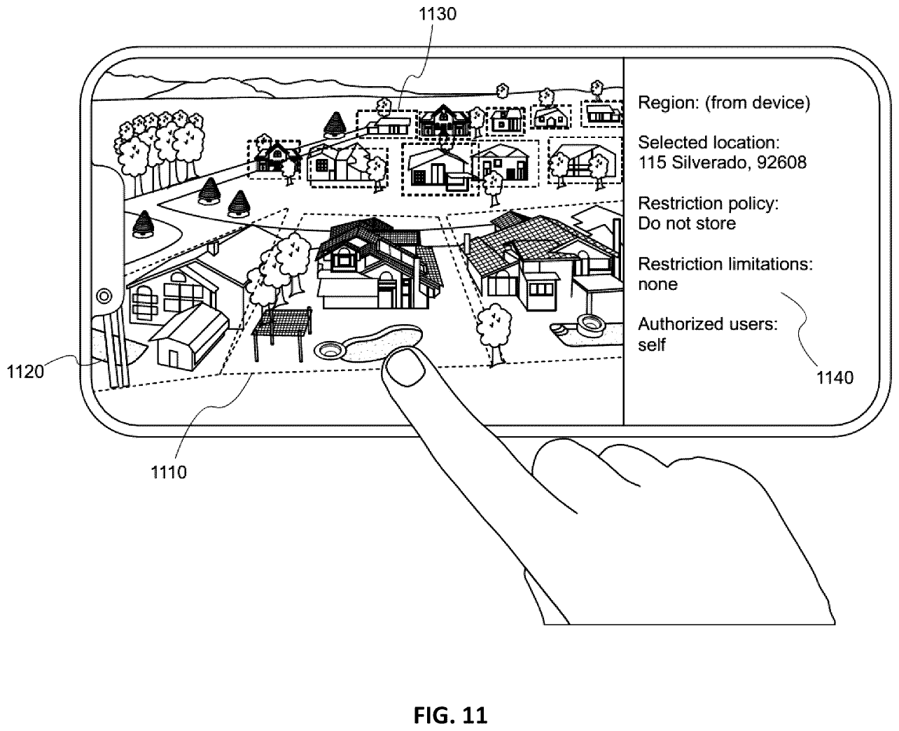

Once the patterns are loaded to the device, or to the external storage accessible by the capture device, while capturing the digital media associated with the target, the capture device, such as via its control circuitry 220 and/or 228 of FIG. 2, may continuously compare the target being captured with each pattern of the database. If a determination is made by the control circuitry 220 and/or 228 that the target matches at least one pattern from the database, then the control circuitry 220 and/or 228 may load the metadata associated with the pattern to the capture device or the external storage associated with the capture device. An example of matching the pattern may be matching the front face of a home displayed in FIG. 11 with a pattern of the home previously uploaded by the homeowner to a privacy platform for preventing others from photographing the home or its occupants.

In some embodiments, the process of pattern matching may include steps of a) data acquisition, filtering and buffering, b) features extraction, and c) pattern matching based on the acquired data and feature extraction. With respect to data acquisition, filtering and buffering, in some embodiments, the control circuitry 220 and/or 228 may acquire data associated with the target to be captured and filter the data as needed. In some embodiments, the data related to the target may be filtered to reduce noise or unwanted artifacts (such as stabilizing a shaky video) as well as preprocessing such as converting to a lower resolution or grayscale for image processing and storing into a temporary storage for further processing. Once the data related to the target has been filtered, in some embodiments, the control circuitry 220 and/or 228 may apply image processing techniques to images or frames of a video captured to identify significant patterns or characteristics of an image or frame. The control circuitry 220 and/or 228 may also apply techniques such as edge detection, corner detection, shape identification, or texture extraction to derive a set of features against which the restriction pattern may be matched. The set of features derived through the feature extraction process may be tagged or associated with feature descriptors such that they are searchable and usable in matching with a pattern. The process of pattern matching may further include robust pattern matching (using Random Sample Consensus {RANSAC} for example) and homographic transformation to detect the presence of a restricted pattern within a video or image feed. In some embodiments, pattern matching may involve matching the derived features of the target with those of the restricted pattern. In other words, the feature matching may involve matching similarities and correspondences between the feature descriptors of the target and the feature descriptors of the restriction patterns computed when the restriction patterns were created. Methods such as scale invariant feature transform (SIFT) may be used to identify patterns within a target even when orientation and scale of the target differ from the objects in the reference restriction pattern.

A margin of error may also be used when performing the pattern match. The margin of error, also referred to as the pattern matching threshold, may allow deviation from the pattern by a certain percentage, such as 1-5%. The pattern matching threshold may be determined by the homeowner uploading the image of their home or automatically by the control circuitry 220 and/or 228. The pattern matching threshold may provide some leeway such that even if the target doesn't match the pattern 100%, it may still determine a match if the match is within the pattern matching threshold. For example, an image being captured of the home at different angles or with some portions of the home obstructed may still be considered to match the pattern of the home if it is within the pattern matching threshold. Once the pattern matches, metadata associated with the pattern may be accessed.

In some embodiments, the metadata includes information that instructs the capture device as to a) whether capture of the target is allowed, and if allowed, under what conditions, b) whether the storing of the captured target is allowed, and if allowed, under what conditions, and c) whether sharing or uploading of the captured digital media associated with the target, such as on a sharing platform, is allowed, and if allowed, under what conditions. Using the example of the home of FIG. 11 described above, the metadata may include rules and instructions relating to capture, storage, and sharing that are uploaded by the homeowner on a privacy platform. For example, metadata may include information on what objects, attributes, people, etc., from the target are to be altered when capturing the digital media associated with the target per the instructions in the metadata. Accordingly, the control circuitry 220 and/or 228 associated with the capture device may then apply the rules and instructions of the policy when capturing, storing, and/or sharing the digital media associated with the target.

In some embodiments, a determination may be made that no pattern in the database matches the target being captured. In such instances, the capture device may then suspend any target alteration, modification, or transformation process and resume the normal capture of the target. In other words, if the capture device, such as the smartphone in block 103, determines while capturing the photo of the home and the person on the lounge chair next to the pool that there is no policy or pattern match associated with the target being captured, then the smartphone may take the photo in its usual mode.

In some embodiments, a determination may be made that a pattern in the database matches the target being captured and that metadata associated with the matched pattern requires alteration, modification, or transformation of the target and/or some of its attributes to allow its capture. In one embodiment, the alteration instructions, which are in the metadata associated with the matched pattern, may require suspending the capture process (or more precisely, suspending the storage of the captured target). In another embodiment, the alteration instructions may require altering the target or certain attributes of the target such that they are unrecognizable. For example, illustratively, if the target is being photographed, voice recorded, or videotaped, the alteration process may require the portion of the target that corresponds to the restricted pattern to be blurred or cut out. If the target is an audio stream and the pattern is an audio signature, the portion of the captured audio stream that matches the restricted audio pattern is muted or distorted in a non-recoverable way. In this example, the audio pattern may be a voice fingerprint, and the alteration instructions may include removing or muting all voice audio data that match the voice fingerprint. Additional actions and alterations that may be performed are described further in relation to FIG. 14.

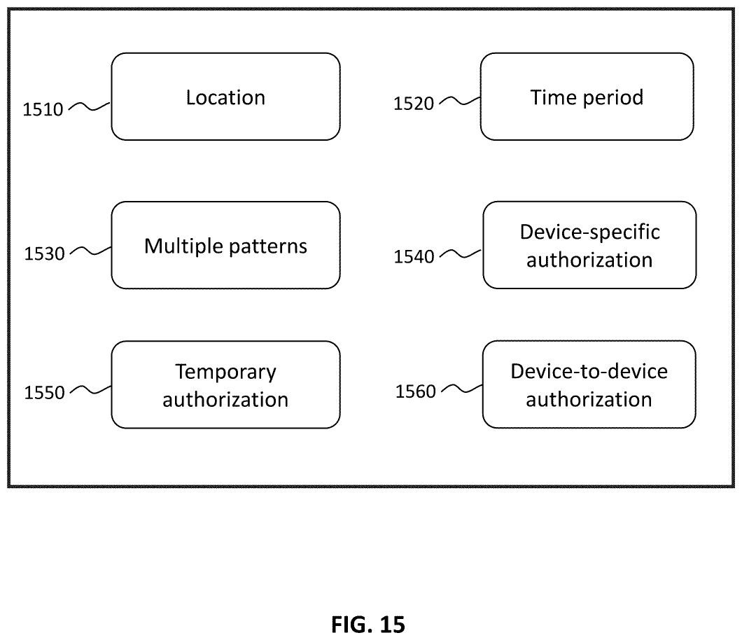

In some embodiments, metadata may also include information relating to location, time periods, temporary authorization, and device specific authorizations. In these embodiments, the rules and restrictions in the policy may be applied only if the listed conditions are met. For example, the rules and restrictions in the policy may be applied only if the target is within a certain location or is being captured within a certain time-frame. For example, a homeowner may routinely sit in their backyard after work, e.g., between the hours of 5-8 p.m. As such, the homeowner may place a condition in the policy that any capture of their backyard be prevented during the hours of 5-8 p.m. Such additional conditions may be added in the metadata by a privacy platform such that when a device tries to capture a photo of the user's backyard, or video record the backyard, it is prevented from doing so between the hours of 5-8 p.m. when the homeowner typically uses the backyard. Additional details relating to location, time periods, temporary authorization, and device-specific authorizations that may be included as conditions in the metadata are discussed in the description of FIG. 15 below.

In one embodiment, at block 103, the device may insert a watermark on the target. Although a watermark is described, another type of mark, symbol, icon, barcode, or marking that may indicate that the target is associated with a policy may also be associated with the target.

The control circuitry 220 and/or 228 may also add metadata to an inserted watermark. Adding of the metadata to the watermark may be performed using a privacy platform. For example, a user may log into the privacy platform, upload an image, identify portions of the image that are to follow a rule of capture and sharing, add metadata that describes the rules and restrictions, and save it to the privacy platform. The privacy platform, in some embodiments, may require the user to identify ownership or authority to upload the images and restrict its capture or sharing. The user may also use natural language or a textual input to provide descriptions related to the authorizations and restrictions associated with the uploaded image of the home. In one embodiment, the user input may then be used to generate a policy (e.g., a restriction policy) that includes the restricted pattern. The system, such as the system in FIG. 2, may then insert/embed a watermark into the image of the restricted pattern, and the user input may be converted into policy rules and instructions that may be added as metadata to the watermark. The system may generate keys that are then provided to the capture device to encode the watermark and place it on the captured image. The encoded message may then be read only by the privacy platform or another authorized user. In some embodiments, once the watermark is applied, the privacy platform may store the capture with the watermark and its associated policy separately in another database. As described earlier, the watermark may include metadata that describes the nature of the watermark, e.g., to search for a particular policy, or describe which alterations have been done or need to be done to the image.

In some embodiments, the watermark generated, and placed on the target, may include metadata that identifies the policy that the watermark is governed by. When the target is in the process of being captured or shared, the capturing device, sharing platform, or privacy platform, may detect the watermark. Since the payload/metadata associated with the watermark may have been encrypted using a public key, the capturing device, sharing platform, or privacy platform may decode the watermark using a private key. For example, if a public key is used to encrypt the watermark and its payload, then a private key shall be used to decrypt it. In other embodiments, only a private key provided to an authorized user may be used to decrypt the watermark and its payload. Both the public/private keys, which allow encryption and description respectively, may be part of the restriction policy's metadata. In operation, in one embodiment, the capture device may receive the public key and use it to encrypt the payload of the watermark with it. The decryption key (i.e., the private key) may be shared with the owner of the policy (originator) and the sharing platform. The sharing platform may then use the decryption key to decode the watermark payload and get the policy ID. As such, the sharing platform may be made aware of which policies to apply when it retrieves the policy associated with the policy ID and apply its restrictions. As described earlier, the policy restriction may also be applied by the privacy platform in communication with the sharing platform.

If the device that captured the target, or any other device, attempts or requests to upload and share or post the target that includes the watermark or some other marking on a sharing platform (such as a social media platform), at block 104, the sharing platform performs a plurality of determinations to ensure that the target being posted complies with the restriction policy that provides guidelines related to its sharing. In one embodiment, one of the determinations made by the sharing platform includes detecting whether a pattern restriction-based alteration is present in a target being posted or shared on their platform and automatically transmit said target to the privacy platform. Upon receipt of the digital media associated with the target, the privacy platform may decrypt the watermark and extract the restriction pattern identifier and identify the user associated with the restriction pattern, such as the homeowner or resident of FIG. 11. It may further alter the target to account for all the restriction patterns not originally applied to the target such as, for example, if the target was captured by a device belonging to another user with restriction patterns associated with this another user. The privacy platform may then notify the homeowner that an altered target has been shared and make the further-altered target available to the homeowner to consult. In the case of a visual target, the privacy platform may also make bounding boxes visible to the homeowner.

In another embodiment, another determination made by the sharing platform may be to determine, for each target being shared on its platform, whether the target includes a watermark or another type of marking. If the target includes a watermark, then the sharing platform may determine if a policy is associated with the watermark. In some embodiments, the sharing platform may communicate with an external service to determine whether the watermark is associated with a policy. For example, a central privacy platform may maintain all policies that may be accessed by the sharing platform. The sharing platform may search the privacy platform using the metadata associated with the watermark to determine if a policy for the matching metadata exists. If a determination is made that a policy associated with the watermark does exist, then the sharing platform may determine where the target received complies with the policy. In some embodiments, the policy may have required that changes or transformations be performed to various attributes of the digital media associated with the target prior to its sharing. In some embodiments, the device that captured the target may have already implemented such changes according to the policy. The sharing platform, as such, may determine whether the changes required by the policy were already performed on the target. If a determination is made that the changes were not performed, then the sharing platform may perform the changes and transformations of attributes associated with the target in compliance with the policy. If a determination is made that the changes were already performed in compliance with the policy, then the sharing platform may allow sharing of the digital media associated with the target on its platform as directed by the policy. In some embodiments, the sharing platform may notify the user who is posting the target if the target does not comply with the policy.

FIG. 2 is a block diagram of an exemplary system for detecting or generating a restriction policy and implementing the restriction policy related to capturing, storing, and sharing of data, in accordance with some embodiments of the disclosure and FIG. 3 is a block diagram of a user device used for capturing, storing, and sharing of data, implementing data capture, store, and share policies, and uploading data to various platforms, in accordance with some embodiments of the disclosure. FIGS. 2 and 3 also describe example devices, systems, servers, and related hardware that may be used to implement processes, execute user interface operations, and all other steps, functions and functionalities described at least in relation to FIG. 1, and 4-16. Further, FIGS. 2 and 3 may also be used for allowing a user to upload an image, video, and/or audio, such as to a privacy platform,, analyzing the uploaded image, video, and/or audio and generating a restriction pattern based on instructions provided by the user, identifying the identity, ownership, and authorization of the user to ensure that the user has proper authority to generate restrictions and rules on how the uploaded image, video, and/or audio is to be restricted when it is being captured, stored, or shared, obtaining instructions, rules, and restrictions from the user and associating them as metadata with a captured target, generating a restriction policy and associating it by location or other parameters, detecting location of a capturing device, searching for restriction policies within a predetermined distance of the capturing device, determining the model and type of capturing device to determine its range and then estimate the location of the target that the device is attempting or requesting to capture, determining whether a pattern associated with the target being digitally captured is restricted based on a restriction policy,, performing actions on the target in compliance with the rules and restrictions of the restriction policy before allowing capture of the target, if the policy does not allow the capture, preventing the capturing device from capturing or storing the target, altering or modifying the target, such as by blurring the image, distorting the image, overlaying other objects on a restricted portion of the image to hide the portion or attribute to be restricted per the restriction policy, adding a watermark and metadata to the target to associate it with a restriction policy, preventing sharing of the target on a media platform, such as a social media platform, if the watermark and associated policy restricts such sharing, altering or modifying the target in compliance with the restrict ion policy prior to allowing its upload to the social media platform for sharing, providing notifications to the user, including notifying the user if the desired restrictions cannot be accomplished, notifying the capturing device if the target is not allowed to be captured, if the target is a house or related structure, obtaining images from third-party websites that are associated with the house to automatically upload as restriction patterns, determining whether multiple restriction patterns such as nested restriction patterns that conditionally allow capturing, storing, and sharing of the target are associated with the target to be captured and if so, applying the rules and restrictions associated with the multiple patterns, utilizing AI and ML algorithms for performing pattern matching and implementing the restriction policy, and performing functions related to all other processes and features described herein.

In some embodiments, one or more parts of, or the entirety of system 200, may be configured as a system implementing various features, processes, functionalities and components of FIG. 1, and 4-16. Although FIG. 2 shows a certain number of components, in various examples, system 200 may include fewer than the illustrated number of components and/or multiples of one or more of the illustrated number of components.

System 200 is shown to include a computing device 218, a server 202 and a communication network 214. It is understood that while a single instance of a component may be shown and described relative to FIG. 2, additional instances of the component may be employed. For example, server 202 may include, or may be incorporated in, more than one server. Similarly, communication network 214 may include, or may be incorporated in, more than one communication network. Server 202 is shown communicatively coupled to computing device 218 through communication network 214. While not shown in FIG. 2, server 202 may be directly communicatively coupled to computing device 218, for example, in a system absent or bypassing communication network 214.

Communication network 214 may comprise one or more network systems, such as, without limitation, internet, LAN, Wi-Fi or other network systems suitable for audio processing applications. In some embodiments, system 200 excludes server 202, and functionality that would otherwise be implemented by server 202 is instead implemented by other components of system 200, such as one or more components of communication network 214. In other embodiments, server 202 works in conjunction with one or more components of communication network 214 to implement certain functionality described herein in a distributed or cooperative manner. Similarly, in some embodiments, system 200 excludes computing device 218, and functionality that would otherwise be implemented by computing device 218 is instead implemented by other components of system 200, such as one or more components of communication network 214 or server 202, or a combination. In still other embodiments, computing device 218 works in conjunction with one or more components of communication network 214 or server 202 to implement certain functionality described herein in a distributed or cooperative manner.

Computing device 218 includes control circuitry 228, display 234 and input circuitry 216. Control circuitry 228 in turn includes transceiver circuitry 262, storage 238 and processing circuitry 240. In some embodiments, computing device 218 or control circuitry 228 may be configured as electronic device 300 of FIG. 3.

Server 202 includes control circuitry 220 and storage 224. Each of storages 224 and 238 may be an electronic storage device. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 4D disc recorders, digital video recorders (DVRs, sometimes called personal video recorders, or PVRs), solid state devices, quantum storage devices, gaming consoles, gaming media, or any other suitable fixed or removable storage devices, and/or any combination of the same. Each storage 224, 238 may be used to store various types of content (e.g., restriction patterns, rule and restrictions associated with restriction patterns, uploaded images, videos, audio files, watermarks, locations of targets, restriction policies associated with various parameters including locations, capturing device model and capability, public and private keys, regions related to uploaded images that are outlined by users, user's identification, ownership, and authorization information, and, AI and ML algorithms). Non-volatile memory may also be used (e.g., to launch a boot-up routine, launch an app, render an app, and carry out other instructions). Cloud-based storage may be used to supplement storages 224, 238 or instead of storages 224, 238. In some embodiments, data relating to., restriction patterns, rule and restrictions associated with restriction patterns, uploaded images, videos, audio files, watermarks, locations of targets, restriction policies associated with various parameters including locations, capturing device model and capability, public and private keys, regions related to uploaded images that are outlined by users, user's identification, ownership, and authorization information, AI and ML algorithms, and data relating to all other processes and features described herein, may be recorded and stored in one or more of storages 224, 238.

In some embodiments, control circuitry 220 and/or 228 executes instructions for an application stored in memory (e.g., storage 224 and/or storage 238). Specifically, control circuitry 220 and/or 228 may be instructed by the application to perform the functions discussed herein. In some implementations, any action performed by control circuitry 220 and/or 228 may be based on instructions received from the application. For example, the application may be implemented as software or a set of executable instructions that may be stored in storage 224 and/or 238 and executed by control circuitry 220 and/or 228. In some embodiments, the application may be a client/server application where only a client application resides on computing device 218, and a server application resides on server 202.

The application may be implemented using any suitable architecture. For example, it may be a stand-alone application wholly implemented on computing device 218. In such an approach, instructions for the application are stored locally (e.g., in storage 238), and data for use by the application is downloaded on a periodic basis (e.g., from an out-of-band feed, from an internet resource, or using another suitable approach). Control circuitry 228 may retrieve instructions for the application from storage 238 and process the instructions to perform the functionality described herein. Based on the processed instructions, control circuitry 228 may determine a type of action to perform in response to input received from input circuitry 216 or from communication network 214. For example, in response to detecting an attempt or request to capture an image, the control circuitry 228 may determine whether the image to be captured is associated with a restriction policy, and if so, the control circuitry 228 may determine the image or any portion of the image matches a restricted pattern in the policy. The control circuitry 228 upon determining that a match exists, may apply restrictions as indicated in the restriction policy prior to allowing the capture of the image. For example, the control circuitry 228 may blur an individual depicted in the image to be captured prior to allowing the capture by a camera. The control circuitry 228 may also perform steps of processes described in FIGS. 1, 4, 6-10, 12-13, 14 and 16, including determining whether a target that is being captured, stored, or shared online is subject to a restriction policy and if so, applying the rules and restrictions indicated in the restriction policy prior to allowing its capturing, storing, or sharing.

In client/server-based embodiments, control circuitry 228 may include communication circuitry suitable for communicating with an application server (e.g., server 202) or other networks or servers. The instructions for carrying out the functionality described herein may be stored on the application server. Communication circuitry may include a cable modem, an Ethernet card, or a wireless modem for communication with other equipment, or any other suitable communication circuitry. Such communication may involve the internet or any other suitable communication networks or paths (e.g., communication network 214). In another example of a client/server-based application, control circuitry 228 may run a web browser that interprets web pages provided by a remote server (e.g., server 202). For example, the remote server may store the instructions for the application in a storage device. The remote server may process the stored instructions using circuitry (e.g., control circuitry 228) and/or generate displays. Computing device 218 may receive the displays generated by the remote server and may display the content of the displays locally via display 234. This way, the processing of the instructions is performed remotely (e.g., by server 202) while the resulting displays, such as the display windows described elsewhere herein, are provided locally on computing device 218. Computing device 218 may receive inputs from the user via input circuitry 216 and transmit those inputs to the remote server for processing and generating the corresponding displays. Alternatively, computing device 218 may receive inputs from the user via input circuitry 216 and process and display the received inputs locally, by control circuitry 228 and display 234, respectively.

Server 202 and computing device 218 may transmit and receive content and data such as data relating to restriction patterns, rule and restrictions associated with restriction patterns, uploaded images, videos, and audio files, watermarks, locations of targets, restriction policies associated with various parameters including locations, capturing device model and capability, public and private keys, regions related to uploaded images that are outlined by users, user's identification, ownership, and authorization information, and, AI and ML algorithms and input from primary devices and secondary devices, such as cameras associated with drones. Control circuitry 220, 228 may send and receive commands, requests, and other suitable data through communication network 214 using transceiver circuitry 260, 262, respectively. Control circuitry 220, 228 may communicate directly with each other using transceiver circuits 260, 262, respectively, avoiding communication network 214.

It is understood that computing device 218 is not limited to the embodiments and methods shown and described herein. In nonlimiting examples, computing device 218 may be an electronic device, a personal computer (PC), a laptop computer, a tablet computer, a WebTV box, a personal computer television (PC/TV), a PC media server, a PC media center, a handheld computer, a mobile telephone, a smartphone, or any other device, computing equipment, or wireless device, and/or combination of the same capable of suitably determining capturing, storing, and sharing of a target and applying rules and restrictions to the target if the target's pattern matches a restriction pattern included in the policy. Control circuitry 220 and/or 228 may be based on any suitable processing circuitry such as processing circuitry 226 and/or 240, respectively. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores). In some embodiments, processing circuitry may be distributed across multiple separate processors, for example, multiple of the same type of processors (e.g., two Intel Core i9 processors) or multiple different processors (e.g., an Intel Core i7 processor and an Intel Core i9 processor). In some embodiments, control circuitry 220 and/or control circuitry 228 is configured for allowing a user to upload an image, video, and/or audio, such as to a privacy platform, receiving, uploaded images, videos, and/or audio files, providing public and private keys for encrypting and decrypting watermarks, analyzing the uploaded image, video, and/or audio and generating a restriction pattern based on instructions provided by the user, identifying the identity, ownership, and authorization of the user to ensure that the user has proper authority to generate restrictions and rules on how the uploaded digital media (e.g., image, video, and/or audio) is to be restricted when it is being captured, stored, or shared, obtaining instructions, rules, and restrictions from the user and associating them as metadata with a captured target, generating a restriction policy and associating it by location or other parameters, detecting location of a capturing device, searching for restriction policies within a predetermined distance of the capturing device, determining the model and type of capturing device to determine its range and then estimate the location of the target that the device is attempting to capture, determining whether a pattern associated with the target being digitally captured is restricted based on a restriction policy, performing actions on the target in compliance with the rules and restrictions of the restriction policy before allowing capture of the target, if the policy does not allow the capture, preventing the capturing device from capturing or storing the target, altering or modifying the target, such as by blurring the image, distorting the image, overlaying other objects on a restricted portion of the image to hide the portion or attribute to be restricted per the restriction policy, adding a watermark and metadata to the target to associate it with a restriction policy, preventing sharing of the target on a media platform, such as a social media platform, if the watermark and associated policy restricts such sharing, alerting or modifying the target in compliance with the restrict ion policy prior to allowing its upload to the social media platform for sharing, providing notifications to the user, including notifying the user if the desired restrictions cannot be accomplished, notifying the capturing device if the target is not allowed to be captured, if the target is a house or related structure, obtaining images from third-party websites that are associated with the house to automatically upload as restriction patterns, determining whether multiple restriction patterns such as nested restriction patterns that conditionally allow capturing, storing, and sharing of target are associated with the target to be captured and if so, applying the rules and restrictions associated with the multiple patterns, and utilizing AI and ML algorithms for performing pattern matching and implementing the restriction policy, and performing functions related to all other processes and features described herein.

Computing device 218 receives a user input 204 at input circuitry 216. For example, computing device 218 may receive data relating to a capturing device attempting to capture a target or share a captured target on social media. As referred to herein, attempting to capture includes any attempts made by using an electronic device to capture the digital media associated with the target. For example, opening the camera app on the capturing device, having the image in the viewfinder of a camera, pressing a record button on the capturing device, selecting a camera icon in a messaging app, such as in WhatsApp, or a social app, such as in Facebook, turning on a live streaming, turning on a podcast app, flying over or near a target with a drone having its camera on, tracking another device's GPS, may all be considered an attempt to capture. As will be described later, although the capturing device may attempt or request to capture digital media associated with the target, the server, privacy platform, or control circuitry may prevent such capture, allowing such capture subject to rules and restrictions associated with the capture. In some embodiments, the request to attempt to capture may be denied by a server and communicated to the capture device.

Transmission of user input 204 to computing device 218 may be accomplished using a wired connection, such as an audio cable, USB cable, ethernet cable or the like attached to a corresponding input port at a local device, or may be accomplished using a wireless connection, such as Bluetooth, Wi-Fi, WiMAX, GSM, UTMS, CDMA, TDMA, 3G, 4G, 4G LTE, 5G, 5G sidelink (5G NRV2X), 6G, or any other suitable wireless transmission protocol. Input circuitry 216 may comprise a physical input port such as a 3.5 mm audio jack, RCA audio jack, USB port, ethernet port, or any other suitable connection for receiving audio over a wired connection or it may comprise a wireless receiver configured to receive data via Bluetooth, Wi-Fi, WiMAX, GSM, UTMS, CDMA, TDMA, 3G, 4G, 4G LTE, or other wireless transmission protocols.

Processing circuitry 240 may receive input 204 from input circuitry 216. Processing circuitry 240 may convert or translate the received user input 204 that may be in the form of voice input into a microphone. In some embodiments, input circuitry 216 performs the translation to digital signals. In some embodiments, processing circuitry 240 (or processing circuitry 226, as the case may be) carries out disclosed processes and methods. For example, processing circuitry 240 or processing circuitry 226 may perform processes as described in FIGS. 1, 4, 6-10, 12-13, 14 and 16, respectively.

FIG. 3 is a block diagram of a user device used for capturing, storing, and sharing of data, implementing data capture, store, and share policies, and uploading data to various platforms, in accordance with some embodiments of the disclosure. In an embodiment, the equipment device 300, is the same equipment device 218 of FIG. 2. The equipment device 300 may receive content and data via input/output (I/O) path 302. The I/O path 302 may provide audio content. The control circuitry 304 may be used to send and receive commands, requests, and other suitable data using the I/O path 302. The I/O path 302 may connect the control circuitry 304 (and specifically the processing circuitry 306) to one or more communications paths or links (e.g., via a network interface), any one or more of which may be wired or wireless in nature. Messages and information described herein as being received by the equipment device 300 may be received via such wired or wireless communications paths. I/O functions may be provided by one or more of these communications paths or intermediary nodes but are shown as a single path in FIG. 3 to avoid overcomplicating the drawing.

The control circuitry 304 may be based on any suitable processing circuitry such as the processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 or i9 processor). In client/server-based embodiments, the control circuitry 304 may include communications circuitry suitable for receiving and transmitting images, videos, and/or audio files, such as to/from a privacy platform or to/from a capturing device, providing public and private keys for encrypting and decrypting watermarks placed on images, videos, and audio file,, analyzing the uploaded image, video, and/or audio and generating a restriction pattern based on instructions provided by the user, identifying the identity, ownership, and authorization of the user to ensure that the user has proper authority to generate restrictions and rules on how the uploaded image, video, and/or audio is to be restricted when it is being captured, stored, or shared, obtaining instructions, rules, and restrictions from the user and associating them as metadata with a captured target, generating a restriction policy and associating it by location or other parameters, detecting location of a capturing device, searching for restriction policies within a predetermined distance of the capturing device, determining the model and type of capturing device to determine its range and then estimate the location of the target that the device is attempting or requesting to capture, determining whether a pattern associated with the target being digitally captured is restricted based on a restriction policy, performing actions on the target in compliance with the rules and restrictions of the restriction policy before allowing capture of the target, if the policy does not allow the capture, preventing the capturing device from capturing or storing the target, altering or modifying the target, such as by blurring the image, distorting the image, overlaying other objects on a restricted portion of the image to hide the portion or attribute to be restricted per the restriction policy, adding watermark and metadata to the target to associate it with a restriction policy, preventing sharing of the target on a social media platform if the watermark and associated policy restricts such sharing, alerting or modifying the target in compliance with the restrict ion policy prior to allowing its upload to the social media platform for sharing, providing notifications to the user, including notifying the user if the desired restrictions cannot be accomplished, notifying the capturing device if the target is not allowed to be captured, if the target is a house or related structure, obtaining images from third-party websites that are associated with the house to automatically upload as restriction patterns, determining whether multiple restriction patterns such as nested restriction patterns that conditionally allow capturing, storing, and sharing of target are associated with the target to be captured and if so, applying the rules and restrictions associated with the multiple patterns, and utilizing AI and ML algorithms for performing pattern matching and implementing the restriction policy, and performing functions related to all other processes and features described herein.

The instructions for carrying out the above-mentioned functionality may be stored on one or more servers. Communications circuitry may include a cable modem, an integrated service digital network (ISDN) modem, a digital subscriber line (DSL) modem, a telephone modem, ethernet card, or a wireless modem for communications with other equipment, or any other suitable communications circuitry. Such communications may involve the internet or any other suitable communication networks or paths. In addition, communications circuitry may include circuitry that enables peer-to-peer communication of primary equipment devices, including communication of primary equipment devices in locations remote from each other (described in more detail below).

Memory may be an electronic storage device provided as the storage 308 that is part of the control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVRs, sometimes called a personal video recorder, or PVRs), solid-state devices, quantum-storage devices, gaming consoles, gaming media, or any other suitable fixed or removable storage devices, and/or any combination of the same. The storage 308 may be used to store various types of content, (e.g., restriction patterns, rule and restrictions associated with restriction patterns, uploaded images, videos, audio files, watermarks, locations of targets, restriction policies associated with various parameters including locations, capturing device model and capability, public and private keys, regions related to uploaded images that are outlined by users, user's identification, ownership, and authorization information, and, AI and ML algorithms). Cloud-based storage, described in relation to FIG. 3, may be used to supplement the storage 308 or instead of the storage 308.

The control circuitry 304 may include audio-generating circuitry and tuning circuitry, such as one or more analog tuners, audio-generation circuitry, filters or any other suitable tuning or audio circuits or combinations of such circuits. The control circuitry 304 may also include scaler circuitry for upconverting and down converting content into the preferred output format of the electronic device 300. The control circuitry 304 may also include digital-to-analog converter circuitry and analog-to-digital converter circuitry for converting between digital and analog signals. The tuning and encoding circuitry may be used by the electronic device 300 to receive and to display, to play, or to record content. The circuitry described herein, including, for example, the tuning, audio-generating, encoding, decoding, encrypting, decrypting, scaler, and analog/digital circuitry, may be implemented using software running on one or more general purpose or specialized processors. If the storage 308 is provided as a separate device from the electronic device 300, the tuning and encoding circuitry (including multiple tuners) may be associated with the storage 308.

The user may utter instructions to the control circuitry 304, which are received by the microphone 316. The microphone 316 may be any microphone (or microphones) capable of detecting human speech. The microphone 316 is connected to the processing circuitry 306 to transmit detected voice commands and other speech thereto for processing. In some embodiments, voice assistants (e.g., Siri, Alexa, Google Home and similar such voice assistants) receive and process the voice commands and other speech.

The electronic device 300 may include a user input interface 310. The interface 310 may be any suitable user interface, such as a remote control, mouse, trackball, keypad, keyboard, touchscreen, touchpad, stylus input, joystick, or other user input interfaces. A display 312 may be provided as a stand-alone device or integrated with other elements of the electronic device 300. For example, the display 312 may be a touchscreen or touch-sensitive display. In such circumstances, the interface 310 may be integrated with or combined with the microphone 316. When the interface 310 is configured with a screen, such a screen may be one or more monitors, a television, a liquid crystal display (LCD) for a mobile device, active-matrix display, cathode-ray tube display, light-emitting diode display, organic light-emitting diode display, quantum-dot display, or any other suitable equipment for displaying visual images. In some embodiments, the interface 310 may be HDTV-capable. In some embodiments, the display 312 may be a 3D display. The speaker (or speakers) 314 may be provided as integrated with other elements of electronic device 300 or may be a stand-alone unit.

The equipment device 300 of FIG. 3 can be implemented in system 200 of FIG. 2 as primary equipment device 202, but any other type of user equipment suitable for allowing communications between two separate user devices for performing the functions related to capturing, storing, and sharing or targets, determining if targets are associated with restriction policies, applying the rules and restrictions of the restriction policies as applicable, and implementing machine learning (ML) and artificial intelligence (AI) algorithms, and all the functionalities discussed associated with the figures mentioned in this application.

FIG. 4 is a flowchart of a process 400 for detecting or generating a policy and implementing the policy related to capturing and sharing of data, in accordance with some embodiments of the disclosure. The process 400 may be implemented, in whole or in part, by systems or devices such as those shown in FIGS. 2 and 3. One or more actions of the process 400 may be incorporated into or combined with one or more actions of any other process or embodiments described herein. The process 400 may be saved to a memory or storage (e.g., any one of those depicted in FIGS. 2 and 3) as one or more instructions or routines that may be executed by a corresponding device or system to implement the process 400.

In some embodiments, at block 405, control circuitry of a system, such as control circuitry 220 and/or 228 of system 200 in FIG. 2, determines a target being captured by a capture device. As described earlier, the target may be any person, structure, object, scenery or landscape, either in its entirety or any one of its portions or attributes, and a capture device may be any electronic device that includes a camera or is associated with a camera for capturing an image, taking a video, or recording audio and has functionality to communicate the captured data with another device, or server, or over a network. Some examples of targets may be a face of a person, a video of an event, an image of a backyard having a pool (e.g., image taken by a drone), an audio recording of a live event, such as a concert or a speech, etc.

At block 410, once a determination is made that the capture device is attempting or requesting to capture a target, the capture device's location and device parameters may be determined. The location determined is the location of the capture device at the time of attempted capture of the target. The location of the capture device may be used to estimate a likely location of the target being captured, such as within 10 feet, one block, one mile, etc., based on the type of target being captured and the device type and parameters (e.g., smartphone with a capture range of 100 meters, drone with a capture range of two miles, etc.) The location of the capture device (which is used to estimate the location of the target) is determined, in some embodiments, to perform a focused and targeted search for a restriction policy that may be associated with a location. Since there may be numerous restriction policies generated either by users or automatically generated for capture of targets, the policy may be anchored to the location or a region to allow for the focused and targeted search and also to save searching and computing resources. For example, in a particular city such as San Jose, 5000 homeowners may have uploaded an image of their homes as a restricted pattern and described policies under which a picture or video of their home can be taken and shared on media platforms, such as a social media platform. Since process 400 involves searching a policy associated with the target being captured and matching the target's pattern with the restricted pattern uploaded by the user to identify the right policy associated with the target and implement the policy, if the control circuitry 220 and/or 228 were to search for policies without identifying a location, their search may result in identifying all 5000 policies and restricted patterns that have been uploaded by the 5000 homeowners. Accordingly, to save computing resources and perform a more focused search, a location of the capturing device may be used to narrowly search within a specific neighborhood of the city which may, in some embodiments, result in only five policies, instead of the 5000 policies that would have otherwise had to be examined to determine which policy relates to the target being captured. Although location may be one parameter to narrow the search for a policy, the embodiments are not so limited, and other parameters, such as name of person or object, person or object ID numbers, and any other searchable parameters, may also be used to conduct a focused and narrow search for a policy associated with the target.

At block 415, in some embodiments, a determination may be made whether there are one or more policies for the location determined at block 410. In one embodiment, at block 415, a determination may be made that there is at least one policy associated with the location. In response to determining that there is at least one policy, the control circuitry 220 and/or 228 may then proceed to block 420 to determine whether the policy includes a restriction pattern. As described earlier the restriction pattern may be uploaded by a user to a privacy platform. The restriction pattern may identify the target that has associated with it a policy that describes various authorizations and restrictions for capturing and sharing of the digital media associated with the target. For example, the homeowner of the house in FIG. 11 may upload an image of their home, and the image may be converted into a restriction pattern automatically by an artificial intelligence engine. The restriction pattern generated may include its shape, colors, design, and all attributes that can identify the image uploaded. The restriction pattern generated may also include details layout and illumination of primary colored pixels (e.g., red, green and blue RGB). It may also include pixel pattern. It may further include distinctive features, tags, and other associations that uniquely identify the image loaded. For example, using the example of FIG. 11, once an image of the backyard of the home is uploaded by the homeowner, the AI engine may automatically generate a restriction pattern for the home that includes the shape and architecture of the home, identification of windows and doors at different locations of the home, location of the pool, dimensional relationships between each attribute of the home (e.g., pool is five meters from the backyard door), coordinates of attributes, any further attribute of the home, such as the pool, windows, backyard chairs, solar panels, and include all other identifying features and attributes as visible in the uploaded image. In some embodiments, the identified policy may include a single pattern while in other embodiments the identified policy may include multiple patterns. The identified policy may further describe the relationship between the multiple patterns, such as which pattern is allowed to be captured and which pattern is not. It may also include instructions such as only if one pattern has not matched should a search for a second pattern be performed.

In another embodiment, a determination may be made, at block 415, that there are multiple policies associated with the location determined at block 410. When multiple policies are detected for the location, the control circuitry 220 and/or 228 may perform further analysis to identify the correct policy associated with the target being captured. For example, the control circuitry 220 and/or 228 may further narrow the search by limiting identifying the location of the capture device and limiting the distance of the search to a smaller range or radius or perimeter around the capture device. For example, if a search for a policy was previously conducted searching for all policies within a one-mile radius, then a more narrowed search for within 100 yards of the current location of the capture device may be made to identify the current policy from the multiple policies identified at block 415. The search to narrow the search and select a single policy from the multiple policies identified may also include using one or more attributes of the target being captured along with the location.

In case of a target that is not attached to a geographic location, such as the voice print or the face of a user, the privacy platform may still compute a probability of a region covered by a capture device to intersect or transect with a region in which the target is present. The probability of the target location may be computed using the last known location of the target's own capture device, such as the user's smartphone. To ensure that this information is available, the privacy platform may have requested the registration of a smartphone when registering a new user-attached restriction pattern. For example, a user may only be allowed to upload their images, video, and audio files and associated restriction patterns if the user's device shares their device location.

If a determination is made, at block 415, that one or more policies do not exist for the location identified in block 410, then, at block 440, the control circuitry 220 and/or 228 may determine whether their target is a restricted or a well-known target. Some examples of restricted targets may include celebrities, politicians, public figures, or any other well-known entities. Examples of other restricted targets may include a private event, such as a speech, a meeting, or a social gathering. A target may also include an event for which payment is required for admission, such as a concert, ball game, museum, outdoor garden, or theme park. It may also include restricted areas where drones are not permitted, such as airports, government buildings, or defense or military areas.

Whether a target is a well-known target may be determined based on a search of the internet by the control circuitry 220 and/or 228 or based on the control circuitry 220 and/or 228 utilizing an AI engine to determine whether such a target is typically restricted or should be restricted from being captured without seeking proper authorization. For example, an AI engine may automatically determine that a drone trying to videotape a concert, which is a private event for which payment is required, is likely trespassing, and should not be allowed to capture the target. Likewise, an AI engine may automatically determine that a target, that is an inside of a celebrity home, even though there is not a policy, should be restricted to provide the celebrity their privacy and as such a policy may be automatically generated.

If a determination is made, at block 440, that the target is a restricted target, then control circuitry 220 and/or 228 may automatically generate a new policy, at block 450. The newly generated policy's restriction rules, which may also be automatically created, may then be applied to the target being captured. In some embodiments, the automatically generated new policy may be provided to the owner of the target for approval at block 460.

If a determination is made, at block 440, that the target is not a well-known target, then the process may proceed to block 445 where the capture of the target in its normal course may be allowed.

At block 420, a determination may be made whether the policy identifies a restriction pattern. The pattern, which may include metadata, may be uploaded by the homeowner on a privacy platform.

If a determination is made, at block 420, that the policy does not include a pattern, then the control circuitry 220 and/or 228 may determine, at block 455, whether the target pattern matches the pattern of a restricted or well-known entity. If a determination is made that the digital media associated with the target, e.g., a restricted pattern within the digital media, matches that of a well-known entity, then the control circuitry 220 and/or 228 may automatically generate a new policy and perform the steps of 430 and 460 as described earlier. However, if a determination is made, at block 455, that the target pattern does not match the pattern of a restricted or well-known entity, then the capture may be allowed at block 445.

Referring back to block 420, once the determination is made that the policy identifies a pattern, then, at block 425, a determination may be made whether the target matches the pattern. In some embodiments, the policy may include a percentage of error allowed between matching the pattern of the target and the restricted pattern. This percentage of error may be input it into the policy to allow for small variations of the target still being within the umbrella of the restricted pattern. For example, if the target being captured is being captured at a different angle, zoom level, or resolution, or is being obstructed by another object, it should still be considered to be a match with the restricted pattern not eliminated solely based on how the capture is taking place. Using the example of FIG. 11, if the restricted pattern shows a 0° angle of the restricted pattern of the home, i.e., the uploaded image of the home is taken keeping the camera in a straight line with the center of the home, and a capture device is trying to capture the same home from a 10° angle, then the variation in angle alone should not eliminate the target from being considered as a match with the restricted pattern. As such, if the policy, as an example, includes a 0 to 20° margin of error in the angle of capture, then the capture device capturing the home at the 10° angle, assuming all other attributes of the target match the restricted pattern, would still be considered as a match with the restricted pattern.

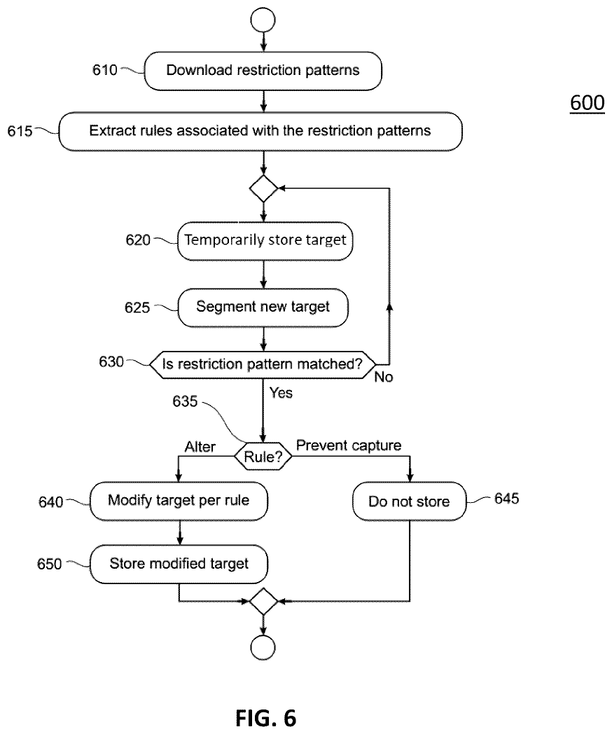

If a determination is made, at block 425, that the target matches the restricted pattern, then, at block 430, a determination may be made whether the policy actions can be performed by the capture device. In other words, if the policy requires, such as for the home in FIG. 11, to be blurred when there are people present near the pool, the determination, at block 430, may involve determining whether the device has the capability to perform the blurring as instructed in the policy. The process of the capturing device matching the pattern and implementing policy actions is described further in the description of FIG. 6.

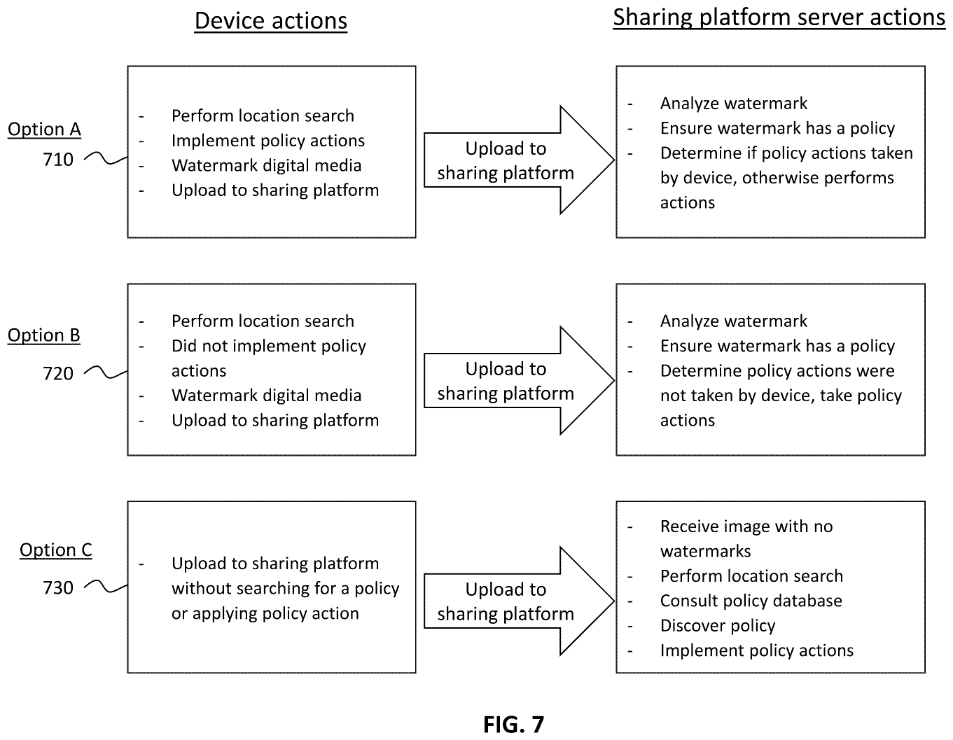

In some embodiments, if a determination is made that the device has the capability to perform the actions described in the policy, then, at block 435, the device may implement the policy by performing the actions. Examples of several types of actions that may be performed on the target are described further in the description of FIG. 14. In addition to performing the action, the capturing device may also insert a watermark on the target captured. Such insertion of watermarking may provide an indication to a recipient of the target, such as a sharing platform, that the target is associated with a policy. If a determination is made, at block 430, that the device does not have the capability to perform the actions instructed in the policy, then the device may add a watermark to the target, at block 465, that indicates that there is a policy associated with the captured target. In such circumstances where the device cannot perform the policy actions, then the sharing platform may perform the actions that are required by the policy and cannot be performed by the capturing device. Some examples of the device actions and the sharing platform actions are described in the description related to FIG. 7 As described earlier, the policy may be applied at various parts of the capture and sharing process. For example, the policy rules may restrict the capturing itself of the target, while other policy rules may allow capturing of the target, but the sharing may be subject to rules and conditions of the policy. In other embodiments, the policy may allow sharing of the target only on certain sharing platforms and not others. In yet other embodiments, the policy may require alterations and/or modifications of the target, or portions or attributes of the target, prior to it being shared on a sharing platform.

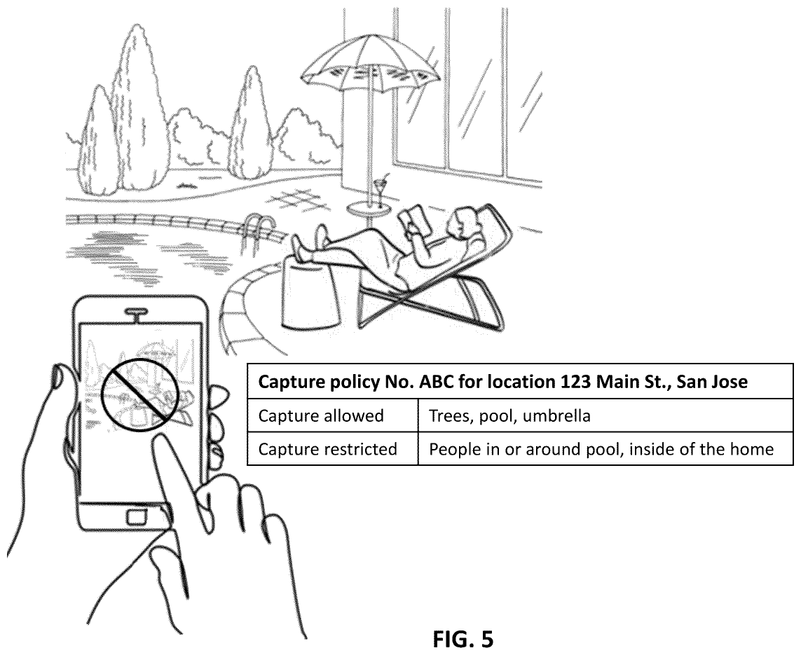

When the policy restricts the capture itself, such as the capture being displayed in FIG. 5, then the control circuitry 220 and/or 228, in some embodiments, may display a symbol or provide a notification to the user who is capturing the digital media associated with the target. The symbol or notification may be displayed on the user interface of the smartphone in FIG. 5. The notification may further indicate that the capture is not allowed. In some embodiments, the user may obtain further details of why the capture is not allowed by selecting the notification. For example, the notification may provide details of the policy and what attributes are prevented from capture. The user, having learned of the policy, which may restrict capture of the pool area only when a person is being depicted in the picture, may retake the picture at a different angle that avoids the person being in the image to comply with the policy. In some embodiments, the user may ask for directions on how to capture the image without violating the policy. In other embodiments, in addition to providing the symbol or notification, the control circuitry 220 and/or 228 may guide the user on the user interface by pointing arrows to change their angle of capture such that the image can be captured without violating the policy. For example, to comply with the policy, arrows may be depicted guiding the user to orient the smartphone more towards the left such that some portions of the pool and the trees can be captured without having the lady in the image.

Once the capture device has either implemented the policy actions, added the watermark to the target, or both performed policy actions and added the watermark, if the target is being uploaded to a sharing platform, the sharing platform may perform its own analysis on the target prior to allowing sharing and posting of the digital media associated with the target on its platform. Further details associated with the sharing platform actions are described in FIGS. 7-9.

FIG. 6 is another example of a flowchart of a process for determining a restricted pattern and modifying data captured based on the rules and policies associated with capturing and sharing of the restricted pattern, in accordance with some embodiments of the disclosure. The process 600 may be implemented, in whole or in part, by systems or devices such as those shown in FIGS. 2 AND 3. One or more actions of the process 600 may be incorporated into or combined with one or more actions of any other process or embodiments described herein. The process 600 may be saved to a memory or storage (e.g., any one of those depicted in FIGS. 2 AND 3) as one or more instructions or routines that may be executed by a corresponding device or system to implement the process 600.

In some embodiments, the capture device such as a smartphone or a drone may perform the actions of searching for a policy based on a location, implementing policy actions, watermarking the captured target, and uploading it to a sharing platform, such as depicted in Option A 710 of FIG. 7. In other embodiments, the capture device may perform Options B 720 and C 730 instead, and the sharing platform may perform the remaining steps of implementing the policy actions.

In some embodiments, where the capture device performs the policy actions, the process 600 may include, at block 610, downloading restriction patterns. As described earlier, to not overload the capture device's memory, only those restriction patterns that are associated with policies related to the target may be downloaded. This process may involve first identifying a location, or another search parameter, and based on the search parameter identifying a policy associated with the target being captured. Once a policy has been identified, restriction patterns associated with the policy may be downloaded to the capture device. The download may include the restriction patterns and associated metadata.

At block 615, the control circuitry 220 and/or 228 may extract rules from the restriction patterns metadata. These rules may provide guidance as to whether the target can be captured at all, and if it can be captured, whether it can be stored or shared subject to the rules within the policy.

At 620, the control circuitry 220 and/or 228 may store the target, such as in a temporary memory of the capture device. Temporarily storing the target may allow the control circuitry 220 and/or 228 to evaluate whether such storage is permitted. If at end of the analysis the control circuitry 220 and/or 228 determines that the storage of the target is not permitted, then the target may be deleted from the temporary storage.

In some embodiments, at block 625, the stored target may be segmented into different portions. The segmentation may be for the purposes of analyzing each portion of the target in a focused manner with the restricted pattern. In other embodiments, the stored target as a whole may be compared with the restricted pattern.

In some embodiments, at block 630, the target as a whole, or the segmented portions of the target, may be compared with the restriction pattern to determine whether the target, e.g., a pattern associated with the target, matches the restriction pattern. In some embodiments, prior to comparing the target to the restricted pattern, the target may be filtered and buffered to prepare it for performing the comparison. The filtering, for example, may include eliminating any noise or unwanted artifacts (such as stabilizing a shaky video) as well as preprocessing such as converting to a lower resolution or grayscale for image processing and storing into a temporary storage for further processing. Additionally, features from the target may be extracted such that the features may be compared with the restriction pattern. In some embodiments, while capturing the digital media associated with the target, the capture device may continuously compare the target being captured with each pattern of the database and, upon detection of at least one pattern in the restriction pattern being present in the captured target, load the associated metadata and alter the capture process per the rule, at block 635, in the metadata.

In some embodiments, the application of the rule, at block 635, may result in preventing the capture of the target. In such circumstances, the control circuitry 220 and/or 228 deletes the target from the temporary storage, at block 645. In other embodiments, the application of the rule may allow the capture device to suspend the alteration process for the digital media associated with the target and resume the normal capture process, e.g., to allow taking and storing of the picture of the home in FIG. 11.

In some embodiments, the application of the rule, at block 635, may require altering of the digital media associated with the target. At block 640, the control circuitry 220 and/or 228 may alter and/or modify the target based on the rules and instructions in the policy. In one example, the target alteration instructions may consist of altering the target so that the portion of the target that includes the restricted pattern may be unrecognizable. Illustratively, if the target is a video or an image, the portion of the video or image that corresponds to the restricted pattern is blurred or cut-out. If the target is an audio stream and the pattern is an audio signature, the portion of the captured audio stream that matches the restricted audio pattern is muted or distorted in a non-recoverable way. Such muting may be performed after the audio has been captured but before allowing it to be stored or shared. In an example, the audio pattern may be a voice fingerprint and the alteration instructions may include removing or muting all voice audio data that match the voice fingerprint.

At block 650, the control circuitry 220 and/or 228 may store the modified target, which is a target that has been altered based on the instructions provided in the policy, to the memory of the capture device. The control circuitry 220 and/or 228 may also add a watermark to the modified target to indicate that the target is associated with the restriction policy. In some embodiments, the unaltered media stored in the temporary memory at 620 may be discarded when its altered version is saved in its place.

FIG. 7 is an example of functions performed by a device and sharing platform server for capturing and posting data on a sharing platform, in accordance with some embodiments of the disclosure. In some embodiments, as described by the options below, the capture device may perform some or all the actions that are required in a policy to be performed once the target being captured is matched with the restricted pattern. In other embodiments, the actions required by the policy upon matching the target with the restricted pattern may be performed by the sharing platform's server. In yet other embodiments, some policy actions may be performed by the device while other actions may be performed by the sharing platform server. In yet other embodiments, the capturing device may add a watermark with different types of metadata indicating whether all the actions have been performed or some are still required to be performed as part of the policy. Although a server of the sharing platform is described as performing some or all of the actions required in the policy, the embodiments are not so limited, and as discussed further in relation to FIG. 9, the sharing platform may engage the privacy platform, or some other service associated with the sharing platform, to perform the policy actions.

In some embodiments, as depicted at block 710 (Option A), the capture device may perform a location search to identify a policy applicable to the target based on the location of the capture device and the estimated location of the target within a predetermined distance from the location of the capture device. The capture device may then implement the policy actions as well as add a watermark to the captured target. The capture device, or another device that is not the capture device, may upload the target with the watermark to the sharing platform.

Continuing with Option A, the sharing platform server may analyze the watermark upon receiving a request to load or share a target containing the watermark. The server of the sharing platform may determine whether the watermark is associated with the policy. In some embodiments, the metadata associated with the watermark will indicate that the watermark is associated with the policy. The server associated with the sharing platform may determine if all policy actions have been taken by the capturing device. The server may perform the determination prior to allowing the posting and sharing of the digital media associated with the target with the sharing platform. In some embodiments, if a determination is made that certain policy actions have not been taken, then the server associated with the sharing platform may perform the remaining actions of the policy prior to allowing posting and sharing of the digital media associated with the target. If a determination is made that the server associated with the sharing platform cannot perform one or more of the policy actions, and policy actions remain to be performed prior to sharing the digital media associated with the target on the platform, then the server may either not post the target or notify the user to perform the remaining actions according to policy prior to posting the target on the sharing platform.

In another embodiment, at block 720 (Option B), the capture device may perform a location search to identify a policy applicable to the target. Based on the search, the capture device may identify a policy associated with the target being captured. In this scenario, the capture device may not perform any of the implementations of the policy, e.g., may not later or modify the target prior to sharing it on the sharing platform. The capture device may add a watermark to the captured target and add metadata indicating that the policy actions have not been performed. The capture device, or another device that is not the capture device, may upload the target with the watermark to the sharing platform.

Continuing with Option B, the sharing platform server may analyze the watermark upon receiving a request to load or share a target containing the watermark. Based on the metadata added to the watermark, the server of the sharing platform may determine that the watermark is associated with a restriction policy and actions required by the policy for sharing the digital media associated with the target on a sharing platform have not been performed. The server may then perform the remaining actions per the policy that are required to allow sharing of the digital media associated with the target on the platform. If a determination is made that the server associated with the sharing platform cannot perform any of the policy actions, and policy actions remain to be performed prior to sharing the digital media associated with the target on the platform, then the server may either not post the target or notify the user to perform the remaining actions according to policy prior to posting the target on the sharing platform.

In another embodiment, at block 720 (Option C), the capture device may upload a captured target directly to the sharing platform without searching for a policy or applying any policy actions. In this scenario, in one embodiment, the sharing platform may do all or most of the work of evaluating the target against a policy, determining if the target includes any of the restricted patterns, and if so, applying the rules of the policy, such as blurring some or all of the portions of the target, as required by the policy for posting on the sharing platform. In another embodiment, the sharing platform may leverage the privacy platform or another service to evaluate against the policy and apply any applicable policy actions to the target.

FIG. 8 is an example of a flowchart of a process 800 for a sharing platform server to detect and implement a policy associated with posting or sharing data on the sharing platform, in accordance with some embodiments of the disclosure. The process 800 may be implemented, in whole or in part, by systems or devices such as those shown in FIGS. 2 AND 3. One or more actions of the process 800 may be incorporated into or combined with one or more actions of any other process or embodiments described herein. The process 800 may be saved to a memory or storage (e.g., any one of those depicted in FIGS. 2 AND 3) as one or more instructions or routines that may be executed by a corresponding device or system to implement the process 800.

In some embodiments, at block 810, the sharing platform may detect an attempt or request to upload or post a target (e.g., an image or a video) on the sharing platform. The attempt may be detected when a user via the capturing device or any other type of electronic device tries to upload an image or video using their user interface associated with the sharing platform. For example, the detection may be made when a user uploads an image to their Facebook feed.

At block 820, the sharing platform, such as via its control circuitry 220 and/or 228, may determine whether the image or video includes a watermark. If a determination is made that the target does not include a watermark, then, at block 860, the sharing platform may allow posting of the target in its normal course.

If a determination is made that the target includes a watermark, (indicated by a “Yes” at block 820), then, at block 830, the sharing platform may determine if the watermark is associated with a restriction policy. If a determination is made that the watermark is not associated with a policy (“No” at block 830), then, at block 860, the target may be posted on the sharing platform in its regular course. In some embodiments, there may be metadata added to the watermark that indicates that the watermark is associated with a restriction policy (“Yes” at 830). The metadata associated with the watermark may indicate the type of restrictions that are required by a policy for posting the target to the sharing platform.

At block 840, the sharing platform may determine whether the policy restrictions have been applied to the target. If the capturing device has already applied the policy restrictions (“Yes” at block 840), such as altering or modifying the target, the sharing platform may allow, at block 860, posting of the target on its platform once it confirms that that such restrictions have been applied.

If the sharing platform determines that the policy restrictions for sharing have not been applied, or have been applied only partially (“No” at block 840), then the sharing platform may review and analyze the policy and implement all the policy restrictions before posting the target on the platform. In some embodiments, to apply the policy restriction, at block 850, the sharing platform may leverage the privacy platform or another third party service to apply the policy restrictions. In the event that the policy does not allow sharing of the digital media associated with the target on the sharing platform, or the sharing platform is not able to apply the policy restrictions, then the sharing platform may not allow the posting of the target and may notify the user.

FIG. 9 is an example of a flowchart of communication process 900 between various components of a system for detecting or generating a policy and implementing the policy related to capturing and sharing of data, in accordance with some embodiments of the disclosure. The process 900 may be implemented, in whole or in part, by systems or devices such as those shown in FIGS. 2 AND 3. One or more actions of the process 900 may be incorporated into or combined with one or more actions of any other process or embodiments described herein. The process 900 may be saved to a memory or storage (e.g., any one of those depicted in FIGS. 2 AND 3) as one or more instructions or routines that may be executed by a corresponding device or system to implement the process 900.

In some embodiments, user 910 may register a restriction pattern at 952 in a user account at a privacy platform 920. In some embodiments, the privacy platform 920 may facilitate the creation and distribution of restricted patterns by allowing the user to create restriction patterns based on pictures of their place of residence (owned or rented real property), fingerprints of their voice, pictures or videos of themselves or their relatives, or pictures or videos of items closely related to them such as their car. To avoid abuse, the privacy platform 920 may require “know your customer” steps to be executed by a user before they can register a restriction pattern such as providing a proof of residence and/or a government-issued identification.

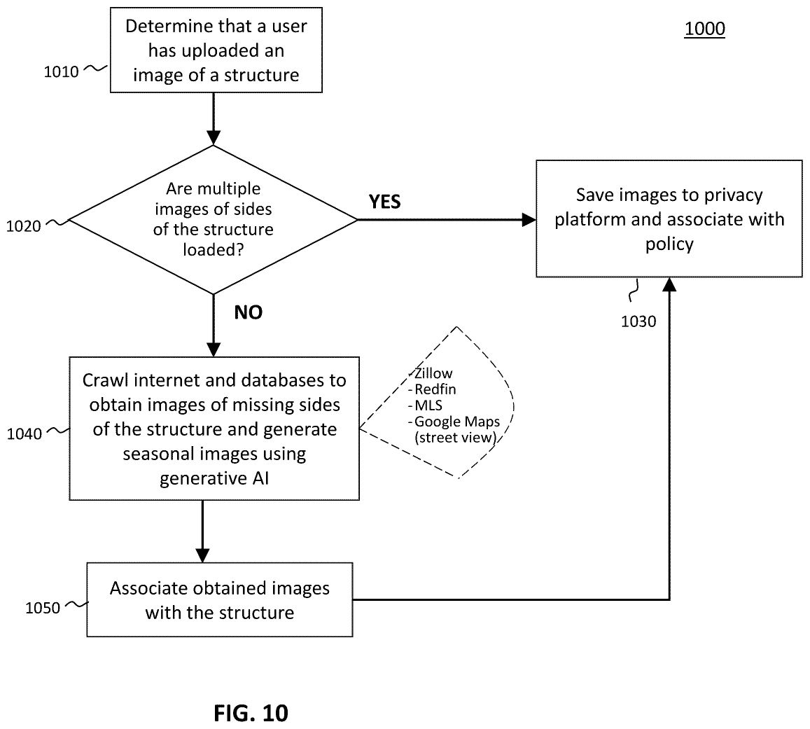

In another example, the privacy platform 920 may allow a user to identify a region on a map and generate a restriction pattern corresponding to what a drone flying over the region would capture. The privacy platform may automatically generate the associated location metadata by computing the minimum range from the region a drone should start testing for a restriction pattern. The privacy platform may also generate a set of image patterns corresponding to various angles at which the restricted region can be captured and rendered within the zone corresponding to the range described earlier. For example, the privacy platform may query (not shown) a property database such as Zillow, Redfin, or MLS to obtain the various angles of images of a home, as will be further described in FIG. 10. The privacy platform may also allow the user to identify a region on a live feed of a capture device to select a restriction pattern.

At 954, privacy platform 920 may generate metadata associated with the restricted pattern. The metadata may include restrictions that the owner of the restriction pattern has provided to the privacy platform. For example, the owner of a home who registers their home's restriction pattern may include instructions on how and when capture of their home is allowed and under what circumstances sharing images of their home on a shared platform is allowed.

Based on the user registration and the generated metadata, in some embodiments, the privacy platform may generate a restriction pattern at 956. The privacy platform at 958 may issue a private key to the capturing device, using which, the capturing device may add a watermark to the digital media associated with the home and encrypt the payload associated with the watermark.

At 962, the capture device 930 may get restriction patterns from the privacy platform 920. The capture device on its own or upon request from the privacy platform 920 may share the capture device's location at 964. The privacy platform 920 may generate a restriction pattern list for the capture device 930 at 966 based on the device's location. For example, the privacy platform having access to all the policies based on locations may determine that the capture device is in a location that is within the radius of a target (whose location and coordinates may be identified in the restriction policy and the restriction policy may be tagged with the location) and as such generate the restricted pattern list for the device to follow rules to comply with the rules associated with the generated restricted pattern.

At 968, in some embodiments, the privacy platform 920 transmits the restriction pattern list to the capture device 930. As described earlier, this list is specific to policies that are identified that are within a certain distance or radius of the capture device. Since the target is likely within a certain distance or radius from the capture device, to not overload the capture device's memory, only the policies that are within the predetermined threshold distance of the target and restricted patterns indicated in the identified policies are transmitted to the capture device.

At 970, the capture device may capture the target. The target may be captured by the camera of the capture device. The capture device's camera range may vary based on the type of capture device. For example, a smartphone with a higher zoom capability may be able to capture digital media associated with the targets that are farther away and at a higher resolution as compared to a smartphone without the zoom lens. In another example, a drone that is at a higher elevation may have a higher visibility and a greater capture range than a smartphone that is on the ground and may have obstructions in its way. Such capture ranges may be based on camera capability, model of capture device, and elevation of the capture device (e.g., a drone or a capture device located in tall building may have a higher elevation and a higher or greater visibility). As described earlier, in some embodiments, the location of the capture device may be used to estimate the location of the target that is being captured. In other words, an estimation may be made that the target being captured is within a predetermined distance of the capture device. As such, if the capture device is a drone, the predetermined distance may be farther (because the drone at a higher elevation may be able to have a farther line of sight without obstructions) than the capture device being a smartphone because of its camera range capabilities and any obstructions in the camera's line of sight.

At 972, the capture device may detect a restriction pattern in the target. In some embodiments, the restriction pattern, which is part of the restriction policy, may be uploaded to the capture device for performing the comparison. The capture device may compare a pattern associated with the target to be captured with the restriction pattern from the restriction policy.

At 974, if the capture device determines a match between the restriction pattern from the restriction policy and a pattern of the target to be captured, then the capture device may alter the target or perform any of the actions required by the restriction policy. Some examples of alterations and modifications that may be performed or other actions instituted by the capture device are listed in FIG. 14.

In some embodiments, determining a match may comprise using image processing to detect and identify a surface of the target. For example, if the target is a house, the image recognition may be used to identify a surface, such as the front of the house, as a pattern. The capture device may then compare the detected pattern of the house with the restriction pattern from the policy. If the restriction pattern from the policy also includes the same or a similar surface of the house, then the capture device may determine a match. Since the match may not be perfect, for example, the capturing device may be positioned at a different angle, at a different resolution, or have some other obstruction in the way, while capturing the digital media associated with the target, a match may still be confirmed if it exceeds at a predetermined threshold. For example, a predetermined threshold of 70% may be allowed by the policy. As such, if 70% of the attributes in the pattern associated with the target to be captured matches 70% of the attributes in the restriction pattern, then the capture device may still determine a match. Continuing with this example, as depicted in FIG. 11, if 70% constitutes the shape of the pool, the layout of the doors and windows, the solar panels, and the roofline's shape of the house, and those 70% attributes match the pattern of the restriction policy, then the capture device may determine a match even if the house is being captured at a different angle or the image is skewed by 30%.

At 976, the capture device may embed a watermark in the captured target (i.e., digital media file). The capture device may also add metadata to the embedded watermark. The metadata may identify which actions are required by the restriction policy when implemented by the capture device on the target. For example, if the restriction policy requires the capture device to alter, blur, or overlay a portion of the target, the metadata associated with the watermark may identify whether such actions were taken by the capture device. Metadata associated with the watermark may also identify the restriction policy associated with that target. In some embodiments, details relating to the restriction policy, such as its link, which database to query to obtain the restriction policy; or rules and restrictions associated with the policy may also be included in the metadata. In some embodiments, the watermark embedded to the digital media associated with the target may be encrypted using a public key and an authorized recipient of the metadata may decrypt it using a private key.

At 978, the capture device may transmit the captured target to a second user, user2 940. User 2 940, who might not be the user that captured the target, may then, at 980, post the captured target on a sharing platform 950.

In some embodiments, the sharing platform 950 may detect an attempt or request to upload a captured target on its platform. In response to the detection, the sharing platform 950 may determine, at 982, whether the target to be uploaded includes a watermark. In response to determining that the target includes the watermark, in some embodiments, the sharing platform 950 may transmit at 984 the target with the watermark to the privacy platform for further analysis. In other embodiments, the sharing platform may query for the restriction policy associated with the watermark based on metadata included with the watermark.

At 984, the privacy platform 920 may receive the target from the sharing platform 950. The privacy platform may then, at 986, extract restriction patterns associated with the target based on the metadata included with the target. The privacy platform 920, at 988, may then alter the target based on rules and restrictions from the restriction policy associated with the restricted pattern. Privacy platform, at 990, may then store the altered target and generate a URL that provides a link to the storage location.

At 992, in some embodiments, the privacy platform 920 may send a notification to the user 910. The notification may include information relating to actions taken on the captured target based on the rules and restrictions associated with the restriction patterns in the restriction policy. The notification may also inform the user 910 that the target has been modified or altered as indicated in the restriction policy. In some embodiments, the notification may indicate that the modifications and alterations as desired by the user, which were inputted by the user at 952, cannot be performed by either capture device, privacy platform, or the sharing platform.

In some embodiments, the user may receive a URL on the privacy platform, such as via a notification to the user's smartphone. The user may then log into their account on the privacy platform. At this juncture, at 994, a private key may be used to decode the target and display it to the user.

FIG. 10 is an example of a flowchart of a process 1000 for filling in blanks, during a policy creation stage, for an uploaded image that is a structure by adding additional images, in accordance with some embodiments of the disclosure. The process 1000 may be implemented, in whole or in part, by systems or devices such as those shown in FIGS. 2 AND 3. One or more actions of the process 1000 may be incorporated into or combined with one or more actions of any other process or embodiments described herein. The process 1000 may be saved to a memory or storage (e.g., any one of those depicted in FIGS. 2 AND 3) as one or more instructions or routines that may be executed by a corresponding device or system to implement the process 1000.

In some embodiments, the Privacy platform may automate the creation of policies for structures, such as homes, by allowing a user to upload a limited number of images of the structure and fill in the blanks by crawling the internet for more. In some embodiments, the control circuitry may generate synthetic views of the structure using generative AI guided by the existing views it has. It may also make seasonal adjustments, lightning conditions adjustments, etc. to ensure the structure is depicted in all climates and from several angles.

The process to do so may involve, in some embodiments, at block 1010, determining that a user has uploaded an image of a structure. The determination may be made at the image uploading and policy creation stage. For example, when a user may have logged into their privacy platform to upload an image of their home and create rules for its capture and sharing. The structure referred to herein may include a house, farm, commercial property, or any other type of property that may have images available on the internet. The structure may also be a house that is listed on websites and platforms that are associated with home sales and purchases, such as Zillow, Redfin, MLS Listing, or real estate broker websites. In another embodiment, the 3D view of the home may be available on google 3D maps, aerial views of homes, and other map-related websites. In some embodiments, various image recognition techniques may be used to identify whether the image uploaded is a structure.

At block 1020, a determination may be made whether multiple sides of the structure are included in the uploaded image. In other words, a determination may be made whether images of a home uploaded show multiple sides, angles, and orientations and under different climates. If a homeowner uploaded only a single image of their home, it may not result in preventing capture and sharing of images taken of the home that are from different sides, angles, and orientations. This is because each image uploaded may be used to compare to a pattern of a target being captured to determine similarity of attributes such that the capture and sharing of the digital media associated with the target follow the rules and restrictions of the policy. Accordingly, if a match of the image to the target, or at least a predetermined threshold of attributes between the uploaded restriction pattern and the pattern of the target to be captured, cannot be determined, then the attempted capture may be allowed. Using the example of FIG. 11, if an image of the backyard of the house was uploaded by a camera positioned on a ground level and centered towards the house, then only the pool and the surface of the house facing the backyard may be captured and uploaded as a restriction pattern in the policy. Since the image is taken from a ground level and centered to the house, attributes of the house, such as the left and right side, windows and shape of the house on the left and right side, roof, and aerial angles of the house may not be captured in the image. As such, if the attempted or requested capture is with a drone, or from the left or right side of the house, which may include other windows, the roof, and different sides of the house that are not in the uploaded images, then such attempted captures may not be restricted as the patterns may not match the pattern of the single uploaded image of the backyard of the house taken from a ground level.

Accordingly, to increase the probability of the match, if a determination is made, at block 1020, that multiple sides, angles, or different views of the structure are not loaded as the patterns, then, at block 1040, the control circuitry 220 and/or 228 may crawl the internet and databases and fill in the blanks by obtaining additional images of the missing sides of the structure. For example, the control circuitry 220 and/or 228 may crawl websites such as Zillow, Redfin, MLS, or Google Maps to obtain different angles of the structure, including aerial views that may be available on such third-party websites. The control circuitry 220 and/or 228 may also use generative AI to generate images of the structure under different lighting, climatic conditions, and seasons such that a variety of images are available and associated with the restriction policy such that when a target is being captured, it is compared to the various forms of images uploaded. The images obtained may then be associated with the structure at block 1050.

If a determination is made at block 1020 that there are multiple images of the structure uploaded that adequately depict the structure from different angles, lighting, seasons, and climatic conditions, then, at block 1030 the images may be stored in the privacy platform and associated with the policy.

FIG. 11 is an example of an outline drawn around a home to list the home's pattern in a restriction policy, in accordance with some embodiments of the disclosure. In some embodiments, the owner or resident of a house, such as the house 1110, may upload an image of their house. The owner or resident of a house may also include restrictions and rules relating to capturing and sharing an image or video of the house. To do so, the user may upload an image of the house on a privacy platform, such as the privacy platform 920 in FIG. 9. In some embodiments, the user may do so by using a user interface and creating an outline around their house or the area that is subject to the policy. In some embodiments, the user may designate different portions of the uploaded image that may be restricted for capturing or sharing. For example, in house 1110, the user may restrict only the swimming pool area and allow capturing of the rest of the house. In yet other embodiments, the user may include a rule that indicates that if the capturing device is in the contact list of the user's smartphone, then the capture device is allowed to capture the image; however, sharing should be subject to certain rules that the user has designated in the policy for sharing. The user may also indicate that the pool, if it includes people swimming in it during the capture, should be blurred such that the people in the swimming pool are not identifiable. The user may also list any actions, such as action described in FIG. 14, to be used in altering or modifying the image or a portion of the image.

In some embodiments, the user interface may allow the user to list, in section 1140, all the restrictions and conditions that the user requires for others to follow when capturing or sharing an image or video of the house.

In some embodiments, a neighborhood may contain a plurality of policies associated with homes in the neighborhood, such as a policy for home 1120 and home 1130. As described earlier, since the policy may be located based on a location search, when there are multiple policies within a radius, e.g., within a close proximity or distance of each other, additional search parameters in addition to location may be used to narrow down the number of policies and identify the exact policy that should be used for the target being captured. For example, in addition to location, certain parameters of the house, such as pool and/or solar panels on the roof, that distinguish the house from other neighboring homes may also be used to narrow down from a plurality of policies to a policy that is associated with the target being captured.

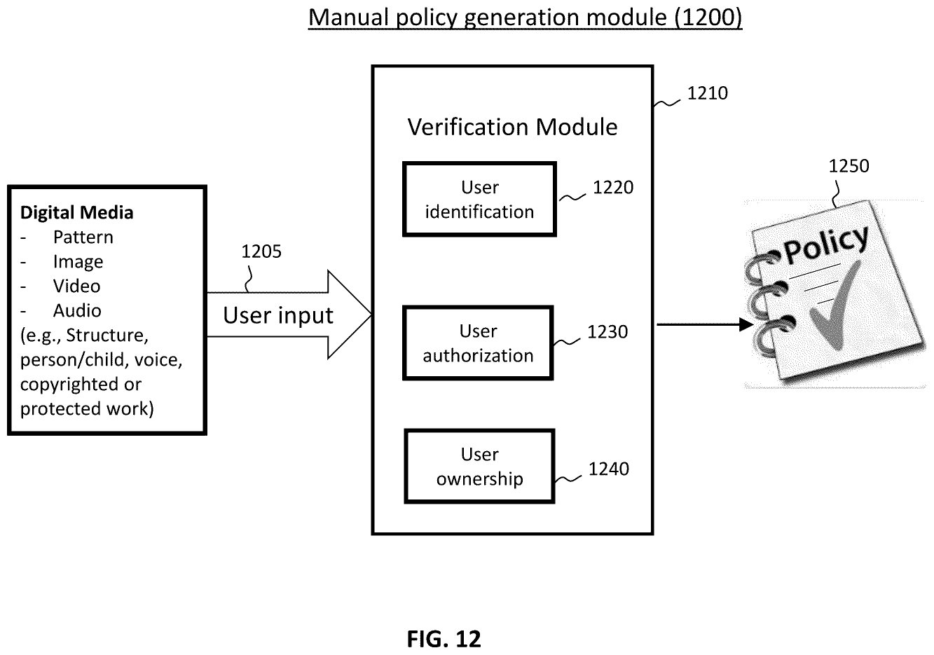

FIG. 12 is an example of a block diagram for manually generating a policy, in accordance with some embodiments of the disclosure. In some embodiments, a user may input a pattern, digital media (e.g., image, video, or audio) as a target that is subject to certain rules and restrictions when it is being captured or shared, such as on social media. Once the user inputs, at 1205, the image, video, or audio, a verification module may perform any one or more of user identification check 1220 to identify the user, user authorization check 1230 to ensure the user is authorized to place restrictions and rules associated with the image, video, or audio, and user ownership check 1240 to ensure the user is the rightful owner of the object thereby giving the user the authority to place restrictions and rules associated with the image, video, or audio.

With respect to user identification 1220, the verification module 1210 may require the user to provide their credentials to verify the user. These credentials may include the user's driver's license, passport, or other official documents that would verify the identity of the user. In some embodiments, the verification module 1210 may require the user to submit proof of user authorization 1230 that allows the user to generate restrictions and rules that restrict the capture or sharing of the digital media associated with the target. If the user is not the owner of the target for which the user has inputted the associated digital media (e.g., its image, video, or audio), the user may still be authorized to generate restrictions and rules if the user has proper permissions from the owner to create such rules and restrictions associated with the capture and sharing of the digital media associated with the target. For example, a resident that is renting a house may still be able to protect images taken of the house and have the proper authorizations from the owner even though the resident is not the owner of the house. In some embodiments, user ownership 1240 may be checked to determine whether the user has authorizations to input rules and regulations associated with the target. User ownership may be proved by providing home ownership papers and ownership papers of an object that the user is willing to restrict from capture and sharing.

These may even include items such as a sales receipt or another official document that would prove ownership of the target.

In some embodiments the verification module may allow the user to input restrictions and rules associated with the image, video, or audio only if any one or more of the verification checks, i.e., user identification, user authorization, or user ownership checks, have been verified. Once the verification module 1210 verifies any one or more verifications associated with the user and their authorization or ownership of the target, then the policy 1250 may automatically be generated. The policy may include a pattern that is generated for the image, video, or audio and include metadata that provides rules and restrictions associated with allowing capturing and sharing of the user input at the target.

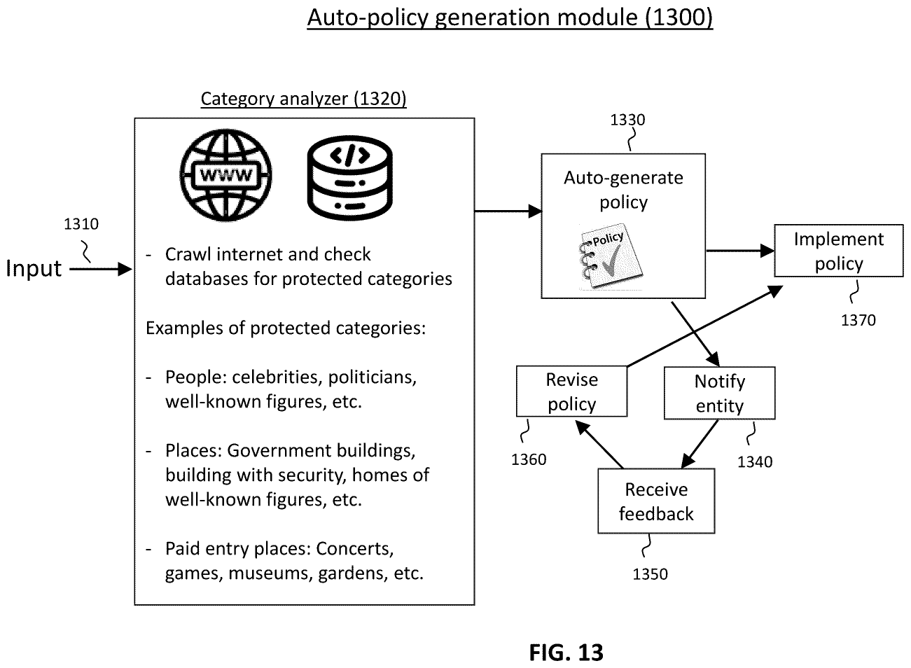

FIG. 13 is an example of a block diagram for automatically generating and revising a policy, in accordance with some embodiments of the disclosure. In this embodiment, the control circuitry 220 and/or 228 may automatically detect an input 1310, which may be an image, video, or audio being captured by the capturing device. This input may be at the stage when the capture device is attempting to capture an image, video, or an audio of the target. In another embodiment, the control circuitry 220 and/or 228 may automatically detect an input 1310, which may be an image, video, or audio being shared on a media platform, such as a social media platform. This input may be detected when digital media associated with the target is uploaded to the social media platform.

If a determination is made that an already captured target that is being uploaded to a sharing platform does not have a watermark on it and/or does not have a restriction policy associated with it, then a category analyzer 1320 may be used to determine whether the target being shared may fall in any one of the protected categories.

In some embodiments, in response to receiving the input 1310, category analyzer 1320 may crawl the internet and also check various databases to determine if the previously captured target that is being uploaded to the sharing platform may fall under a protected category. Examples of the protected categories may include people, such as celebrities, politicians, and well known people. Protected categories may also include places, such as government buildings, buildings with security, and homes of well-known figures. Protected categories may also include paid entry places, such as concerts, games, museums, and gardens, such as the Japanese Tea Garden in San Francisco, to which an entry typically requires a ticket or a payment.

To determine whether the previously captured target that is being uploaded to the sharing platform is associated with a protected category, the category analyzer may use techniques such as image or voice recognition to identify an image our voice of the target and then use that image or voice as part of a search query to crawl and search the internet and databases. If a match is determined between the image or voice associated with the input and any other protected categories, then the category analyzer may classify the target as associated with the protected category.

If the previously captured target associated with the input 1310 is determined to be under a protected category by the category analyzer 1320, then a policy for the target may be auto-generated at 1330. The policy may include rules and regulations that an AI engine determines to be suitable for the type of protected category. For example, if the protected category is a celebrity, an auto-generation policy may include metadata that prevents sharing of the digital media associated with the celebrity under certain inappropriate circumstances, such as when the celebrity is at their home and in their backyard swimming where they have a right to their privacy. As such, the auto-generated policy may require the capturing device to blur, delete, or alter the image of the celebrity from an image previously taken of the house prior to uploading it to the sharing platform such that the celebrity in the altered image is not visible or recognizable.

In some embodiments, once the restriction policy is auto generated, the control circuitry 220 and/or 228 may notify the entity 1340, such as the celebrity represented in the policy, of the policy and its rules and restrictions, receive the celebrity's feedback at1350, and revise the policy 1360 based on the received feedback. Once the restriction policy is auto-generated, and revised if needed, then the policy may be implemented at 1370.

FIG. 14 is a block diagram of examples of actions (alteration and modifications) that may be performed to implement a policy, in accordance with some embodiments of the disclosure. In some embodiments, the restrictions and rules generated in the policy for restricting the capturing and sharing of the digital media associated with the target may require the image, video, or voice of the target to be altered or modified. Some examples of such alterations and modifications that may be performed on the target include blur 1410, overlay 1415, delete 1420, replace 1425, add an avatar 1430, mute 1435, voice change 1440, implement a time restriction 1445, implement a location restriction 1450, implement a platform restriction 1455, and insert a watermark 1460.

In some embodiments, the restrictions from the policy may require the capturing device and/or the privacy or sharing platform to blur 1410 the target before the target can be captured or shared on social media or elsewhere. In these embodiments, the control circuitry 220 and/or 228 may blur the target in its entirety or a portion of the target based on the restriction pattern. For example, the restriction pattern and associated metadata may require blurring of only a specific portion, such as blurring of a person near a swimming pool and not other portions of the target.

In some embodiments, the restrictions from the policy may require the capturing device and/or the privacy or sharing platform to overlay 1415 something on the target before the target can be captured or shared on social media. In these embodiments, the control circuitry 220 and/or 228 may overlay another object on the target or a portion of the target based on the restriction pattern. For example, the restriction pattern and associated metadata may require overlaying only on the pool area of the house.

In some embodiments, the restrictions from the policy may require the capturing device and/or the privacy or sharing platform to delete 1420 the target or a portion of the target before the target can be captured or shared on social media.

In some embodiments, the restrictions from the policy may require the capturing device and/or the privacy or sharing platform to replace 1425 the target before the target can be captured or shared on social media. In these embodiments, the control circuitry 220 and/or 228 may replace the target in its entirety or a portion of the target based on the restriction pattern. For example, the restriction pattern and associated metadata may only require deleting from the target only any people in the backyard with swimsuits on.

In some embodiments, the restrictions from the policy may require the capturing device and/or the privacy or sharing platform to add an avatar 1430 to the target such that addition of the avatar, if allowed by the policy, may allow the target to be captured or shared on a media platform, such as a social media platform. In these embodiments, the control circuitry 220 and/or 228 may replace a person with the avatar and then allow capture and sharing of the digital media associated with the target with the avatar.

In some embodiments, the restrictions from the policy may require the capturing device and/or the privacy or sharing platform to mute 1435 the target after the target is captured but before it can be shared on social media. In these embodiments, the control circuitry 220 and/or 228 may mute a voice or a portion of the voice such that it is not recognizable after capture but before sharing of the digital media associated with the target. Accordingly, the target may then be altered, by muting, and stored in its muted form. As such, when the target is shared, it is already altered, such as by muting.

In some embodiments, the restrictions from the policy may require the capturing device and/or the privacy or sharing platform to alter the voice 1440 of the target after the voice has been recorded but before the voice can be shared on social media. In this embodiment, the control circuitry 220 and/or 228 may alter the voice such that it is unrecognizable and cannot be associated with the user. For example, the circuitry 220 and/or 228 may alter a person's speech, such as by using a computer generated voice, such that the person who uttered the speech cannot be identified based on playing of the recording. Altering of the speech may include using another voice with a different tone, speed, accent, pronunciation, gender, etc.

In some embodiments, the restrictions from the policy may require the capturing device and/or the privacy or sharing platform to implement a time restriction 1445 on the target before the target can be captured or shared on social media. In this embodiment, the control circuitry 220 and/or 228 may allow capturing of the target at all times except when the capture takes place during the time-restriction. For example, the control circuitry 220 and/or 228 may prevent capture of the backyard of the house after 7 p/m., at night hours, and during weekends.

In some embodiments, the restrictions from the policy may require the capturing device and/or the privacy or sharing platform to implement a location-restriction 1450 the target before the target can be captured or shared on social media. In this embodiment, the control circuitry 220 and/or 228 may allow capturing of the target at all locations except the restricted location. For example, the control circuitry 220 and/or 228 may allow photographs of the person to be taken anywhere except their home, place of work, or when they visit a certain location.

In some embodiments, the restrictions from the policy may require the capturing device and/or the privacy or sharing platform to implement a platform-restriction 1450 on the target before the target can be captured or shared on social media. In this embodiment, the control circuitry 220 and/or 228 may allow posting of the target only at specified platforms, such as, for example, on LinkedIn, or Facebook, but not on Instagram.

In some embodiments, the restrictions from the policy may require the capturing device and/or the privacy or sharing platform to add a watermark 1460 to the target before the target can be captured or shared on a media platform, such as a social media platform. As described earlier, the watermark may include metadata that associates the watermark with a restriction policy that is to be followed when capturing or sharing the digital media associated with the target.

FIG. 15 is a block diagram of examples of conditions included in metadata associated with a restricted pattern, in accordance with some embodiments of the disclosure.

In some embodiments, as depicted at block 1510, the metadata associated with a restricted pattern may include a location (e.g., identified through geographical coordinates such as latitude, longitude, and a radius or perimeter around these coordinates). A capture device may then perform a pattern match with the currently captured target and the restricted pattern only if the target is within a threshold proximity or distance of the location indicated in the associated metadata. For example, a first user may generate a pattern representing a first apartment building and associate it with the location of the building, such as 123 Main Street, San Jose, CA. A capture device, which may be a drone, may then suspend capture of the first building upon flying in close proximity to that building because detection of the presence of the building (the pattern) in the captured video (the media) is in close proximity to the 123 Main Street, San Jose, CA location in the metadata. The proximity may be determined by the user, such as the owner or a resident of the building, or by the control circuitry 220 and/or 228 and may be changed as desired. The proximity may create a geo-fence around the target such that any capture within the geo-fence may need to comply with the policy. The proximity and extent of the geofence may be outlined by the user in a privacy platform, such as the outline displayed around the home in FIG. 11. The proximity and extent of the geofence may also be extended such that a drone that can capture the home from a farther distance than a smartphone is prevented from doing so unless it complies with the policy. In another embodiment, no such restriction may apply when the capture device is outside the proximity or geo-fence area and it may be able to capture any other targets, such as other buildings, if similar geo-fences do not exist around them.

In some embodiments, a restriction pattern may not be attached to a geographic location, such as a pattern for a voice print or the face of a user. In such embodiments, the privacy platform may still compute a probability of a region covered by a capture device to intersect or transect with a region in which the user is present and decide to upload the associated restriction pattern to the capture device or not. That probability may be computed using the last known location of the user's own capture device such as their smartphone. To ensure that this information is available, the privacy platform may have requested the registration of a smartphone when registering a new user-attached restriction pattern.

In some embodiments, as depicted at block 1520, the metadata associated with a restricted pattern may include a time-period condition. In this embodiment, the time-periods may be identified through starting date time and an ending date time in a common time reference such as UTC. A capture device may then perform a pattern match with the currently captured target only if the capture and match are within the timeframe of the listed time period. For example, a first user may generate a pattern representing their pool and restrict the capture of video and images from drones overflying their pool between 1 pm and 3 pm on the weekends since that is when the homeowner or other residents of the home use their pool. A capture device, such as a drone flying over their pool, may analyze whether a pattern of the pool and the house matches a restricted pattern. If so, a policy associated with the pattern may be downloaded to the capture device, which includes metadata and conditions listed in the metadata. Since one of the conditions is to restrict capture of the pool area between 1 pm and 3 pm on the weekends, if the capture device is attempting to capture the picture or video recording of the pool area at any other hours outside the restricted time periods, then the capture device may be allowed to do so. However, if the capture device he's attempting to capture a picture, video record the pool, or obtain audio from the poor the area between the restricted hours (i.e., between 1 p.m. and 3 p.m. on the weekends), then applying the policy, the capture device may be prevented from capturing the digital media associated with the target.

In some embodiments, as depicted at block 1530, the metadata associated with a restricted pattern may include multiple patterns. Each pattern, of the multiple patterns, may be associated with different conditions that are to be applied when capturing or sharing the digital media associated with the target. In some embodiments, the multiple patterns may be nested underneath each other in parent-child relationships where a child pattern is analyzed only when a parent pattern is matched. In other embodiments, the policy may be conditional on the matching of more than one pattern from the multiple patterns. In such a case, the metadata associated with the first pattern may include the second pattern and instructions on what to do if the second pattern is detected in concert with the first pattern or not. For example, a first pattern may be the pool from above and a second pattern may be a generic human shape. Upon detection of the presence of the first pattern (the pool) in the target being captured, a drone overflying the pool may then further detect the second pattern (human shapes) and be required to suspend the capture since the homeowner may not want pictures of the family in bathing suits being taken by drones. However, if only the first pattern is detected and the second pattern is not detected, which relates to the pool area not having any people around it, the capture device may be allowed to capture in a normal manner. In more examples, a capture restriction may exist for all combinations of pattern detection. Illustratively, a first restriction (first pattern only) may be to alter the area of the target matching the first pattern and a second restriction (first and second pattern) may be to suspend capture (i.e., not store captured media).

In some embodiments, as depicted at block 1540, the metadata associated with a restricted pattern may include device specific authorizations. In this embodiment, the metadata associated with a restricted pattern may include one or more authorized device identification. If a capture device detects that its own identification matches one of the authorized device identifications, it may ignore the restricted pattern and not test for it in the captured target.

Likewise, in another embodiment, the metadata associated with a restricted pattern may include one or more authorized users. If a capture device detects that the identity of its current user matches one of the authorized users, it may ignore the restricted pattern and not test for it in the captured target. Using device-specific authorization may provide the user of the system or the owner /esident of the target, such as a home, the ability to allow capture of their home by their family members, friends, or other authorized devices, such as a delivery drone. In order to allow such device specific authorizations, attributes of the capturing device, such as device ID, model number, user ID of an account associated with the capture device, or other device identifying attributes may be inputted into a privacy platform.

Accordingly, when a device tries to capture the target, a verification may be made by checking into the privacy platform to determine whether the capture device is one of the devices that has received specific authorization for capturing the digital media associated with the target.

In some embodiments, as depicted at block 1550, the metadata associated with a restricted pattern may include a temporary authorization. In this embodiment, the temporary authorization may not include a start date and is discarded when it expires. When a capture device detects a temporary authorization, it may not test for the associated restricted pattern in the target.

In some embodiments, as depicted at block 1560, a device-to-device authorization, such as a temporary authorization, may be provided. In this embodiment, there may be a first device that is authorized to capture an image and a second device that is not authorized. If a detection is made that the second device is in close proximity to the first device, then the first device may temporarily authorize the second device. The process of doing so may involve a notification being generated by the privacy platform and sent to the first device to grant temporary authorization to the second device. If the first device accepts, then the second device may be authorized to the extent permitted by the first device. For example, a friend of the user may be visiting, and their device may not be authorized to capture a photograph.

However, since the second user is a friend of the first user, and with the first user, the first user may grant temporary authorization.

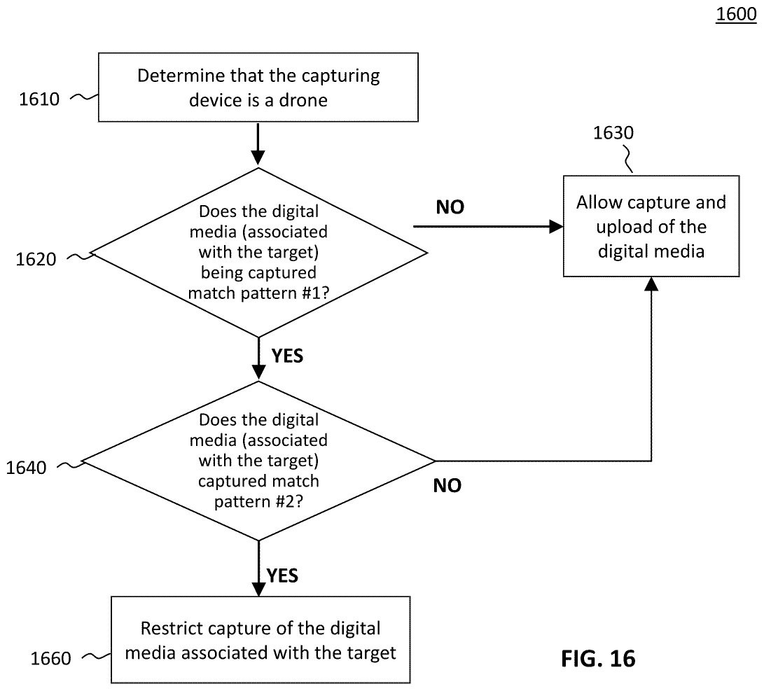

FIG. 16 is an example of a flowchart of a process 1600 for implementing the policy for a drone, in accordance with some embodiments of the disclosure. The process 1600 may be implemented, in whole or in part, by systems or devices such as those shown in FIGS. 2 AND 3. One or more actions of the process 1600 may be incorporated into or combined with one or more actions of any other process or embodiments described herein. The process 1600 may be saved to a memory or storage (e.g., any one of those depicted in FIGS. 2 AND 3) as one or more instructions or routines that may be executed by a corresponding device or system to implement the process 1600.

In some other embodiments, the restriction policy may be conditional on the matching of more than one pattern. In such a case, the metadata associated with the first pattern may include the second pattern and instructions on what to do if the second pattern is detected in concert with the first pattern or not. For example, as depicted in FIG. 5, a first pattern may be the pool and a second pattern may be a generic human shape. Upon detection of the presence of the first pattern (the pool) in the media being captured, a drone overflying the pool may then further detect the second pattern (human shapes) and decide to suspend media capture, whereas upon detection of the first pattern only it may allow the capture to proceed normally. In more examples, a capture restriction may exist for all combinations of pattern detection. Illustratively, a first restriction (first pattern only) may be to alter the area of the media matching the first pattern and a second restriction (first and second pattern) may be to suspend capture (i.e., not store captured media).

In the example of FIG. 16, patterns #1 and #2 may be listed as restricted patterns in a restriction policy. In this example of multiple patterns, the restriction policy may allow capturing of pattern #1 but may prevent capturing of pattern #2.

Referring to block 1610, in some embodiments, a determination may be made that the capturing device is a drone. Although a drone is used as an example, any other type of capturing device is also contemplated within the embodiments.

At 1620, a determination may be made whether the target being captured matches pattern #1. To determine whether the target matches pattern #1, techniques such as image or voice recognition may be used to match attributes of a pattern associated with the target being captured with pattern #1, which is a restricted pattern listed in a restriction policy. If a determination is made, at block 1620, that the target does not match pattern #1, then at 1630, the control circuitry 220 and/or 228 may allow the capture and upload of the target. If a determination is made at block 1620 that the target being captured matches pattern #1, then, another determination may be made, at block 1640, whether the target being captured matches pattern #2.

Since pattern #2 is restricted for capture in this example, if a determination is made, at block 1640, that the target being captured matches pattern #2, then, at 1660, the control circuitry 220 and/or 228 may restrict the capturing device from capturing the digital media associated with the target. If a determination is made, at block 1640, that the target being captured does not include pattern #2, then, control circuitry 220 and/or 228 may allow the capture and upload of the target at 1630.

Although only two patterns have been described in FIG. 16, the embodiments are not so limited and multiple levels and layers of patterns, including nested patterns, are also contemplated within the embodiments. In some embodiments there may be several rules and regulations and if this then that (IFTTT) rules that may be associated with the multiple levels and layers of patterns, including nested patterns such that capture is allowed under certain conditions and not allowed under other conditions. Although FIG. 16 discusses restrictions associated with capturing and sharing of the digital media associated with the target, the restrictions may also apply to storing of the target once captured.

It will be apparent to those of ordinary skill in the art that methods involved in the above-mentioned embodiments may be embodied in a computer program product that includes a computer-usable and/or-readable medium. For example, such a computer-usable medium may consist of a read-only memory device, such as a CD-ROM disk or conventional ROM device, or a random-access memory, such as a hard drive device or a computer diskette, having a computer-readable program code stored thereon. It should also be understood that methods, techniques, and processes involved in the present disclosure may be executed using processing circuitry.

The processes discussed above are intended to be illustrative and not limiting. Only the claims that follow are meant to set bounds as to what the present invention includes.

Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. A method comprising:
detecting an attempt to capture digital media associated with target by an electronic device;
identifying a location of the target in response to detecting the attempt;
determining whether a restriction policy is associated with the identified location; and
in response to determining a restriction policy is associated with the identified location:
comparing the digital media associated with the target to be captured with content from the restriction policy; and
in response to determining a match, based on the comparison, causing the electronic device to perform a predetermined action to the digital media associated with the target to be captured, wherein the predetermined action is described in the restriction policy.

2. The method of claim 1, wherein identifying the location of the target further comprises:
obtaining geographical coordinates of the electronic device that is attempting to capture the digital media associated with the target; and
estimating the location of the target based on the geographical coordinates of the electronic device and a capture range of a camera used by the electronic device to attempt the capture.

3. The method of claim 2, further comprising:
determining that the electronic device is a drone;
obtaining model information associated with the drone;
determining a camera capture range based on the obtained model of the drone; and
estimating the location of the target based on the determined camera capture range of the drone.

4. The method of claim 1, wherein determining whether a restriction policy is associated with the identified location further comprises:
searching a database using the identified location of the target as a search query;
analyzing results from the search to identify one or more restriction policies associated with the location; and
selecting, based on the analysis, a restriction policy from the identified one or more restriction policies as the restriction policy associated with the target.

5. The method of claim 1, wherein comparing the pattern associated with the target to the restriction pattern from the restriction policy further comprises:
using image recognition to identify the target;
identifying, based on the image recognition, one or more pattern for the identified target; and
comparing the one or more pattern for the identified target with the restriction pattern from the restriction policy to determine the match.

6. The method of claim 1, wherein comparing the pattern associated with the target to the restriction pattern from the restriction policy further comprises:
causing to download the restriction pattern from the restriction policy to the electronic device; and
causing the electronic device to automatically perform the comparison using the downloaded restriction pattern.

7. The method of claim 1, further comprising:
determining that the restriction policy includes instructions for watermarking the digital media associated with the captured target; and
causing embedding of the watermark on the digital media associated with the target after its capture based on the instructions from the restriction policy.

8. The method of claim 7, wherein the watermarking includes metadata relating to whether the electronic device performed the predetermined action described in the restriction policy.

9. The method of claim 1, further comprising:
receiving an upload of the digital media associated with the target on a social media platform;
determining whether the digital media associated with the target to be shared is embedded with a watermark; and
in response to determining that the digital media associated with the target to be shared includes the watermark:
analyzing whether the watermark is associated with the restriction policy; and
determining whether restrictions from the restriction policy have been applied prior to allowing the sharing of the digital media associated with the target on the social media platform.

10. The method of claim 9, further comprising:
determining that restrictions from the restriction policy have not been applied to the digital media associated with the target attempted to be shared on the social media platform;
applying the restrictions from the restriction policy in response to determining that restrictions from the restriction policy have not been applied to the target attempted to be shared on the social media platform; and
allowing sharing of the digital media associated with the target on the social media platform after the restrictions from the restriction policy have been applied to the target.

11. The method of claim 1, wherein the restriction policy restricts any one of:
capturing of the digital media associated with the target; and
sharing of captured digital media associated with the target on a social media website.

12. The method of claim 1, further comprising:
providing a platform for uploading a restriction pattern; and
associating the uploaded restriction pattern with the identified location of the target.

13. The method of claim 12, further comprising issuing a cryptographic key that is to be used for uploading the restriction pattern to the platform.

14. A system comprising:
communications circuitry configured to access an electronic device; and
control circuitry configured to:
detect an attempt to capture digital media associated with target by the electronic device;
identify a location of the target in response to detecting the attempt;
determine whether a restriction policy is associated with the identified location; and
in response to determining a restriction policy is associated with the identified location:
compare the digital media associated with the target to be captured with content from the restriction policy; and
in response to determining a match, based on the comparison, cause the electronic device to perform a predetermined action to the digital media associated with the target to be captured, wherein the predetermined action is described in the restriction policy.

15. The system of claim 14, wherein identifying the location of the target further comprises, the control circuitry configured to:
obtain geographical coordinates of the electronic device that is attempting to capture the digital media associated with the target; and
estimate the location of the target based on the geographical coordinates of the electronic device and a capture range of a camera used by the electronic device to attempt the capture.

16. The system of claim 14, wherein determining whether a restriction policy is associated with the identified location further comprises, the control circuitry configured to:
search a database using the identified location of the target as a search query;
analyze results from the search to identify one or more restriction policies associated with the location; and
select, based on the analysis, a restriction policy from the identified one or more restriction policies as the restriction policy associated with the target.

17. The system of claim 14, wherein comparing the pattern associated with the target to the restriction pattern from the restriction policy further comprises, the control circuitry configured to:
use image recognition to identify the target;
identify, based on the image recognition, one or more pattern for the identified target; and
compare the one or more pattern for the identified target with the restriction pattern from the restriction policy to determine the match.

18. The system of claim 14, wherein comparing the pattern associated with the target to the restriction pattern from the restriction policy further comprises, the control circuitry configured to:
cause to download the restriction pattern from the restriction policy to the electronic device; and
cause the electronic device to automatically perform the comparison using the downloaded restriction pattern.

19. The system of claim 14, further comprising, the control circuitry configured to:
receive an upload of the digital media associated with the target on a social media platform;
determine whether the digital media associated with the target to be shared is embedded with a watermark; and
in response to determining that the digital media associated with the target to be shared includes the watermark:
analyze whether the watermark is associated with the restriction policy; and
determine whether restrictions from the restriction policy have been applied prior to allowing the sharing of the digital media associated with the target on the social media platform.

20. The system of claim 19, further comprising, the control circuitry configured to:
determine that restrictions from the restriction policy have not been applied to the digital media associated with the target attempted to be shared on the social media platform;
apply the restrictions from the restriction policy in response to determining that restrictions from the restriction policy have not been applied to the target attempted to be shared on the social media platform; and
allow sharing of the digital media associated with the target on the social media platform after the restrictions from the restriction policy have been applied to the target.

21. (canceled)
